(19) United States
(12) Patent Application Publication
(10) Pub. No.: US 2016/0150252 A1
(43) Pub. Date: May 26, 2016

(54) DISTRIBUTION APPARATUS, DISTRIBUTION METHOD, PLAYBACK APPARATUS, PLAYBACK METHOD, AND PROGRAM

(71) Applicant: SHARP KABUSHIKI KAISHA, Osaka (JP)

(72) Inventor: Shuhichi WATANABE, Osaka-shi (JP)

(21) Appl. No.: 14/899,268

(22) PCT Filed: Jul. 23, 2014
(86) PCT No.: PCT/JP2014/069440

§ 371 Date: Dec. 17, 2015

(30) Foreign Application Priority Data
Jul. 23, 2013 (JP) 2013-153086

(51) Int. Cl. H04N 21/2362; H04N 21/84; H04N 21/435; H04N 21/434; H04N 21/458; H04N 21/235

(52) U.S. Cl. CPC H04N 21/2362; H04N 21/4586; H04N 21/235; H04N 21/435; H04N 21/4345; H04N 21/8402

(57) ABSTRACT

A distribution apparatus (300A) includes a distribution unit (330) that distributes an AIT and a PIT of the same version together. Every time only a PIT (AIT) is updated, the distribution unit (330) distributes the updated version of this PIT (AIT), and also distributes an AIT (PIT) of version 00 indicating that a component will continue to be obtained or played back on the basis of the AIT (PIT) which is not updated.

### TECHNICAL FIELD

The present invention generally relates to a distribution apparatus for distributing content and a playback apparatus for playing back content.

### BACKGROUND ART

As disclosed in PTL 1 as an example, various technologies for transporting some components which form video content by broadcasting and for transporting the remaining components via a communication network by utilizing hybrid transport technologies have been proposed.

Currently, the standardization of MPEG•MMT (MPEG Media Transport protocol), which is a transport scheme for hybrid distribution, is in progress. In this MPEG•MMT, the standardization of, for example, a high-efficiency transport format for distributing multiple components, such as video, audio, and text, in different channels (hybrid distribution), is in progress.

### CITATION LIST

### Patent Literature

PTL 1: Japanese Unexamined Patent Application Publication No. 10-173612 (Publication Date: Jun. 26, 1998)

### SUMMARY OF INVENTION

### Technical Problem

Video content transmitted by the MPEG•MMT transport scheme includes multiple components, such as video, audio, and text. A video receiver obtains from broadcast waves meta information for obtaining and playing back some components to be distributed by broadcasting, and obtains by communication meta information for obtaining and playing back the remaining components to be distributed by communication. More specifically, each item of meta information is constituted by configuration information and composition information. The configuration information indicates a location from which a component may be obtained and the specifications of the component. The composition information specifies the playback method of a component (for example, the display position of a video component).

The video receiver then refers to the configuration information obtained from broadcast waves and obtains some components distributed by broadcasting, and refers to the composition information obtained from the broadcast waves and plays back these components. Similarly, the video receiver refers to the configuration information obtained by communication and obtains the remaining components distributed by communication, and refers to the composition information obtained by communication and plays back these components.

There may be a situation where a provider updates meta information while distributing video content.

It is now assumed, for example, that video content concerning a baseball game is being distributed, and more specifically, a video component of main video of the video content is distributed by broadcasting and a video component of sub video of the video content is distributed by communication. In this case, if a provider wishes to change the display position of the sub video in a video receiver, the provider may update the composition information and restart to distribute the updated composition information by communication.

Moreover, while distributing the video content of the baseball game, if the provider wishes to change the URL from which the video receiver may obtain the sub video, the provider may also update the configuration information and restart to distribute the updated configuration information by communication.

In this manner, there may be multiple versions for configuration information and composition information. Thus, version information may be described in the configuration information and the composition information.

Now, problems that may be raised due to the presence of multiple versions for configuration information and composition information will be discussed below.

If the version of the configuration information stored in a video receiver is different from that of the composition information stored in a video receiver, the video receiver makes a decision whether or not video content will be played back on the basis of the configuration information and the composition information according to the specifications of the video receiver. Thus, the provider may not be able to allow some viewers to view the video content as intended by the provider.

In order to avoid such a situation, every time the contents of at least one of the configuration information and composition information are updated, the version number of the configuration information and that of the composition information may be updated from i to i+1 (i=1, 2, . . . ), and then, the configuration information and the composition information of the updated version number may be distributed as a pair.

However, this method has a drawback. That is, even if there is no change in the contents of one of the configuration information and the composition information, both of the version numbers of the configuration information and the composition information are updated. As a result, there are plural items of configuration information (composition information) that have different version numbers but have the same contents. This is not desirable in terms of the management of the versions of configuration information and composition information in a distribution source.

The present invention has been made in view of the above-described problem. It is a major object of the present invention to implement a distribution apparatus that is able to allow each viewer to view the content as intended by a provider and that distributes configuration information and composition information which are formed to implement the appropriate management of the version numbers of the configuration information and the composition information. It is another object of the present invention to implement a playback apparatus that plays back the content on the basis of configuration information and composition information distributed from this distribution apparatus.

### Solution to Problem

In order to solve the above-described problem, a distribution apparatus according to an aspect of the present invention is a distribution apparatus for distributing configuration information and composition information, the configuration information indicating a location from which at least one of components forming content is obtained, the composition information indicating a playback mode of the at least one of components. The distribution apparatus includes a distributor that distributes the configuration information and the composition information. The distributor distributes one of the configuration information and the composition information, and also distributes information indicating that the at least one of components will continue to be obtained or played back on the basis of the other one of the configuration information and the composition information which has already been obtained.

In order to solve the above-described problem, a playback apparatus according to an aspect of the present invention is a playback apparatus for obtaining and playing back at least one of components forming content on the basis of configuration information and composition information, the configuration information indicating a location from which the at least one of components is obtained, the composition information indicating a playback mode of the at least one of components. The playback apparatus includes: an obtainer that obtains the configuration information and the composition information; a player that performs a playback operation on the basis of the configuration information and the composition information; and an updater that updates, upon obtaining one of the configuration information and the composition information and information indicating that the at least one of components will continue to be obtained or played back on the basis of the other one of the configuration information and the composition information which has already been obtained, the obtained one of the configuration information and the composition information by using the obtained information and updates both of the configuration information and the composition information to a latest version. The player plays back a component which is obtained on the basis of the configuration information of the latest version, on the basis of the composition information of the latest version.

In order to solve the above-described problem, a distribution method according to an aspect of the present invention is a distribution method for distributing configuration information and composition information, the configuration information indicating a location from which at least one of components forming content is obtained, the composition information indicating a playback mode of the at least one of components. The distribution method includes: a first distributing step of distributing the configuration information and the composition information; and a second distributing step of distributing one of the configuration information and the composition information, and also distributing information indicating that the at least one of components will continue to be obtained or played back on the basis of the other one of the configuration information and the composition information which has already been obtained.

In order to solve the above-described problem, a playback method according to an aspect of the present invention is a playback method for obtaining and playing back at least one of components forming content on the basis of configuration information and composition information, the configuration information indicating a location from which the at least one of components is obtained, the composition information indicating a playback mode of the at least one of components. The playback method includes: an obtaining step of obtaining the configuration information and the composition information; a playing step of performing a playback operation on the basis of the configuration information and the composition information; and an updating step of updating, upon obtaining one of the configuration information and the composition information and information indicating that the at least one of components will continue to be obtained or played back on the basis of the other one of the configuration information and the composition information which has already been obtained, the obtained one of the configuration information and the composition information by using the obtained information and updating both of the configuration information and the composition information to a latest version. The playing step plays back a component which is obtained on the basis of the configuration information of the latest version, on the basis of the composition information of the latest version.

### Advantageous Effects of Invention

The distribution apparatus and the distribution method according to an aspect of the present invention achieve the following advantages. It is possible to allow each viewer to view the content as intended by a provider and to distribute configuration information and composition information which are formed to implement the appropriate management of the version numbers of the configuration information and the composition information.

The playback apparatus and the playback method according to an aspect of the present invention achieve the advantage of playing back the content on the basis of configuration information and composition information distributed from the above-described distribution apparatus.

### BRIEF DESCRIPTION OF DRAWINGS

FIG. 1 illustrates a distribution system according to a first embodiment of the present invention and the configuration of the major part of a playback apparatus included in the distribution system.

FIG. 2 shows block diagrams illustrating the configuration of the major part of a distribution apparatus shown in FIG. 1.

FIG. 3 schematically illustrates examples of the data structures of a PIT (Presentation Information Table) and an AIT (Access Information Table) used in the distribution system shown in FIG. 1.

FIG. 4 illustrates an example of a situation where a PIT and an AIT are distributed from each distribution apparatus shown in FIG. 1 and components are presented by the playback apparatus shown in FIG. 1.

FIG. 5 illustrates how the playback apparatus shown in FIG. 1 updates a PIT and an AIT when a PIT or AIT is updated in the distribution apparatus shown in FIG. 1.

FIG. 6 illustrates a distribution system according to a second embodiment of the present invention and the configuration of the major part of a playback apparatus included in the distribution system.

FIG. 7 illustrates how the playback apparatus shown in FIG. 6 updates a PIT and an AIT when a PIT or AIT is updated in a distribution apparatus shown in FIG. 6.

FIG. 8 illustrates a distribution system according to a third embodiment of the present invention and the configuration of the major part of a playback apparatus included in the distribution system.

FIG. 9 illustrates an example of a situation where a PIT and an AIT of the initial version are distributed from a distribution apparatus shown in FIG. 8 and components are presented by the playback apparatus shown in FIG. 8.

FIG. 10 illustrates an example of a situation where, immediately after a PIT is updated for the first time, PITs and AITs are distributed from the distribution apparatus shown in FIG. 8 and components are presented by the playback apparatus shown in FIG. 8.

FIG. 11 illustrates how the playback apparatus shown in FIG. 8 updates a PIT and an AIT when a PIT or AIT is updated in the distribution apparatus shown in FIG. 8.

FIG. 12 illustrates a distribution system according to a fourth embodiment of the present invention and the configuration of the major part of a playback apparatus included in the distribution system.

FIG. 13 schematically illustrates examples the data structures of PATs (Package Access Tables) which are referred to by the playback apparatus shown in FIG. 12 for obtaining a PIT and an AIT.

FIG. 14 illustrates how the playback apparatus shown in FIG. 12 updates a PIT and an AIT when a PIT or AIT is updated in a distribution apparatus shown in FIG. 12.

FIG. 15 illustrates examples of the data structures of a PI message and an AI message.

### DESCRIPTION OF EMBODIMENTS

### First Embodiment

An embodiment of the present invention will be described below in detail.

A distribution system according to an embodiment of the present invention (hereinafter simply referred to as a “distribution system” in a description of this embodiment) is a system that distributes program content by hybrid transport. More specifically, some components forming the program content are distributed by broadcasting, and the remaining components forming the program content are distributed by communication.

The distribution system includes three distribution apparatuses. More specifically, among the three distribution apparatuses, one distribution apparatus distributes main video and main audio components of the program content by broadcasting. One of the remaining two distribution apparatuses distributes sub video 1 of the program content by communication, and the other distribution apparatus distributes sub video 2 of the program content by communication.

The number of distribution apparatuses included in the distribution system may be two or less or four or more. The number and the types of components forming the program content are not particularly restricted.

The present invention supports content playback based on MPEG•MMT. Similarly, each distribution apparatus according to this embodiment supports content distribution based on MPEG•MMT. Hereinafter, a description will be given by using the term “MPEG•MMT” if necessary. However, the present invention is not an invention which has been made only based on the MPEG•MMT technology. That is, the present invention is applicable, not only to MPEG•MMT, but also to various standards and operation technologies.

The configuration of the distribution system will be discussed below with reference to the drawings.

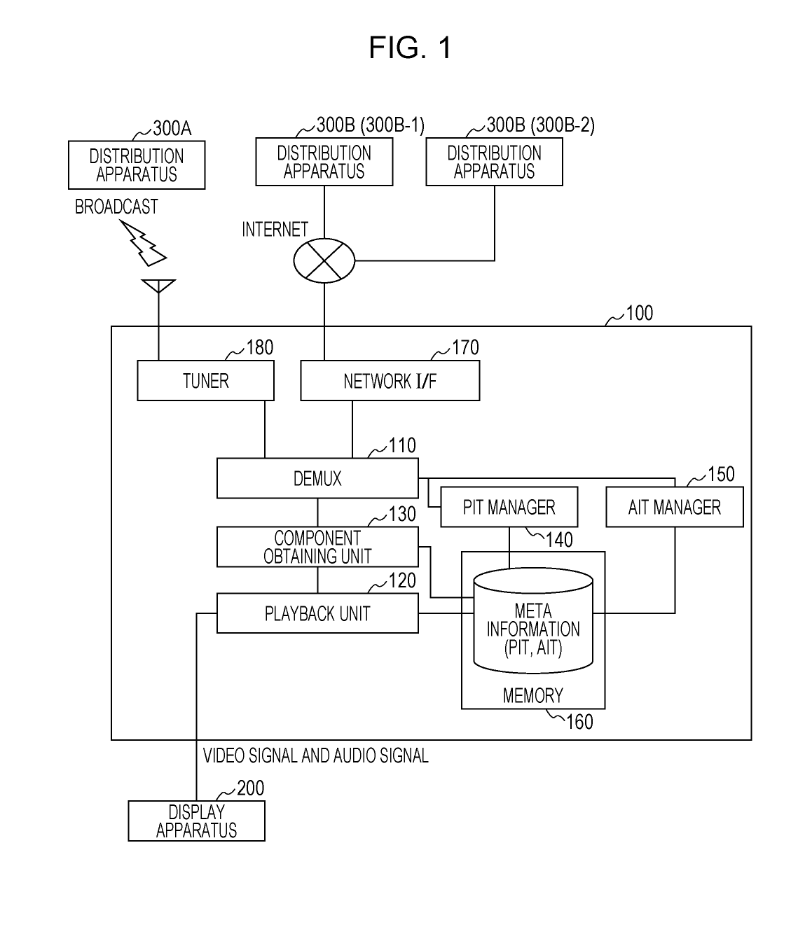

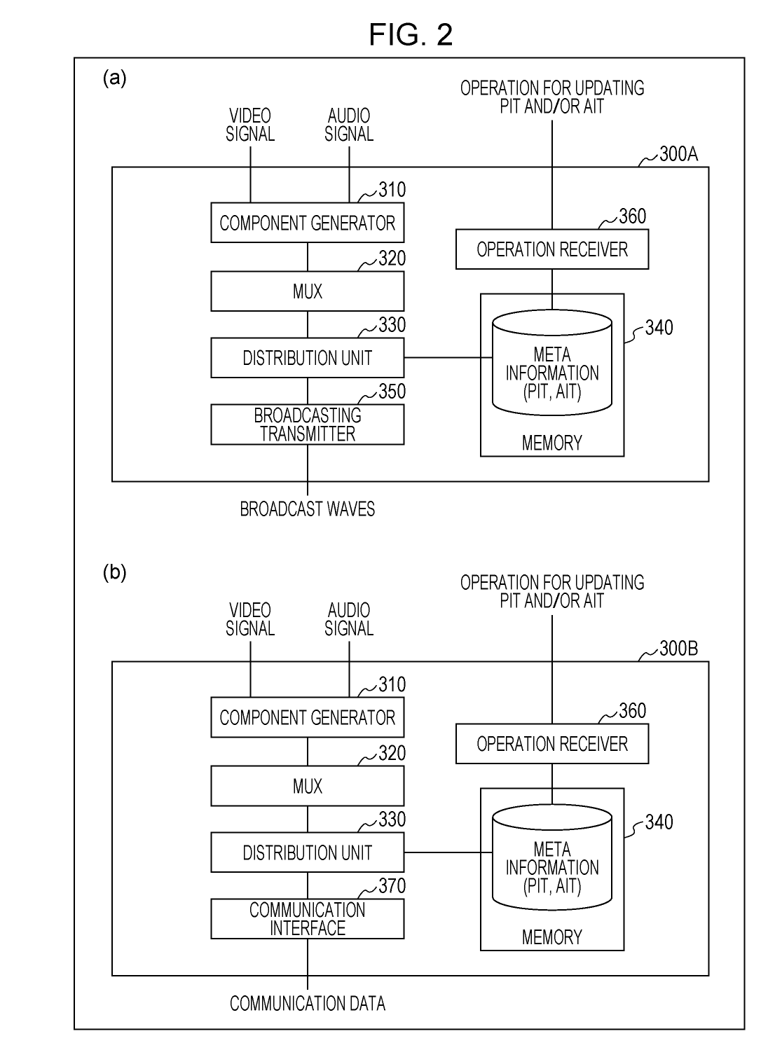

FIG. 1 illustrates the distribution system and the configuration of the major part of a playback apparatus included in the distribution system. Part (a) of FIG. 2 illustrates the configuration of the major part of a distribution apparatus that distributes a component by broadcasting. Part (b) of FIG. 2 illustrates the configuration of the major part of a distribution apparatus that distributes a component by communication.

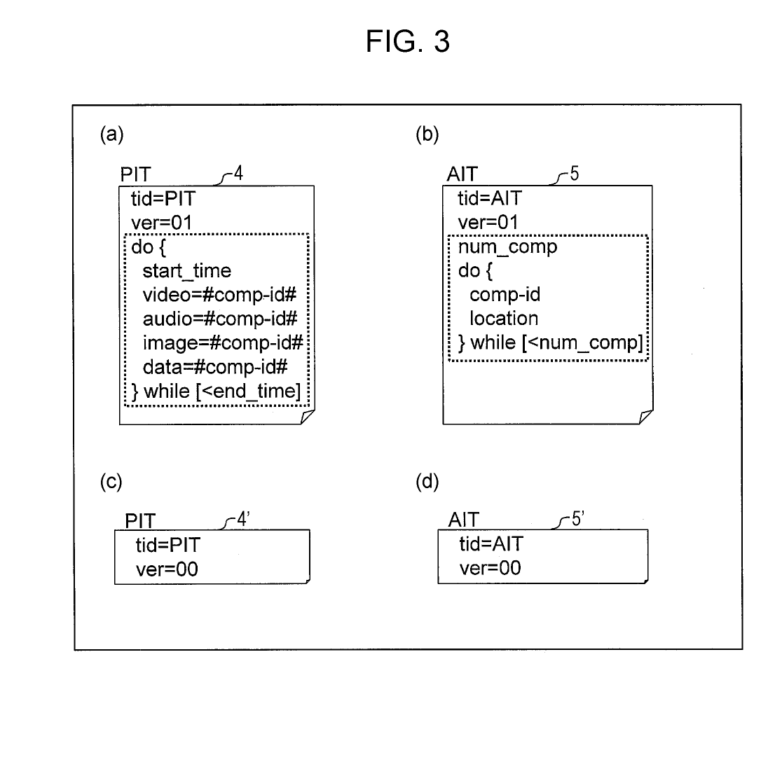

FIG. 3 schematically illustrates examples of the data structures of a PIT (Presentation Information Table) and an AIT (Access Information Table) used in the distribution system. PIT is an example of composition information which specifies the playback method for a component (for example, the display position of a video component). AIT is an example of configuration information which indicates a location from which a component may be obtained and the specifications of the component. PIT and AIT are data corresponding to MCIT (MMT Composition Information Table) and MPT (MMT Package Table), respectively, based on MPEG•MMT.

In FIG. 3, “tid=PIT” and “tid=AIT” indicate the type of table, “ver” indicates the version number, “start_time” indicates the playback time, and “num_comp” indicates the number of components. In FIG. 3, “comp-id” indicates the component ID, and “location” indicates a location from which the component corresponding to the component ID may be obtained (packet ID in the case of broadcasting and URL in the case of communication).

As shown in FIG. 1, the distribution system includes a distribution apparatus 300A that performs distribution by broadcasting, two distribution apparatuses 300B (300B-1 and 300B-2) that perform distribution by communication, a playback apparatus 100, and a display apparatus 200.

The configurations of the major parts of the distribution apparatuses 300A and 300B and the playback apparatus 100 will be described below.

### (Distribution Apparatuses 300A and 300B)

As shown in FIG. 2, the distribution apparatuses 300A and 300B each include a component generator 310, a MUX 320, a distribution unit 330, a memory 340, and an operation receiver 360.

### (Component Generator 310)

The component generator 310 is able to generate a video component and/or an audio component on the basis of a video signal and/or an audio signal input from an external source. The component generator 310 is also able to generate a data component, a still image component, a video component, and an audio component on the basis of BML data, still image data, video data, and audio data stored in an HDD (not shown).

### (MUX 320)

If multiple components are supplied from the component generator 310, the MUX (multiplexer) 320 multiplexes them and also supplies the multiplexed components to the distribution unit 330. If a single component is supplied from the component generator 310, the MUX 320 adds a header including a distribution time to this single component, forms it into a packet, and then supplies this component to the distribution unit 330.

### (Distribution Unit 330)

The distribution unit 330 supplies a single component or multiplexed components supplied from the MUX 320 to a broadcasting transmitter 350 or a communication interface 370. The distribution unit 330 also repeatedly distributes a PIT and an AIT.

Every time both of a PIT and an AIT are updated, the distribution unit 330 repeatedly distributes the PIT and the AIT of the updated version. Every time one of a PIT and an AIT is updated, the distribution unit 330 repeatedly distributes the PIT (or AIT) of the updated version and also repeatedly distributes the AIT (or PIT) having the version number “0”.

### (Memory 340)

The memory 340 is a recording medium in which a PIT and an AIT of each version are stored. This recording medium may be another type of recording medium, such as a hard disk drive.

### (Operation Receiver 360)

The operation receiver 360 receives an operation for updating a PIT and/or an AIT (more specifically, an operation for creating a PIT and/or an AIT of the latest version while a PIT and/or an AIT of an existing version remain being stored in the memory 340).

### (Broadcasting Transmitter 350 and Communication Interface 370)

The distribution apparatus 300A also includes the broadcasting transmitter 350, while the distribution apparatus 300B also includes the communication interface 370.

The broadcasting transmitter 350 transmits data supplied from the distribution unit 330 via broadcast waves.

The communication interface 370 transmits a communication signal indicating data supplied from the distribution unit 330 to a network.

The configurations of the major parts of the distribution apparatuses 300A and 300B have been discussed above.

Then, the configuration of the major part of the playback apparatus 100 will be discussed below with reference to FIG. 1.

### (Playback Apparatus 100)

As shown in FIG. 1, the playback apparatus 100 includes a DEMUX 110, a playback unit 120, a component obtaining unit 130, a PIT manager 140, an AIT manager 150, a memory 160, a network I/F 170, and a tuner 180.

### (DEMUX 110)

The DEMUX 110 demultiplexes multiplexed components received by the previous stage (network I/F 170 or tuner 180) and supplies the demultiplexed components to the component obtaining unit 130. The DEMUX 110 supplies a single component received by the previous stage to the component obtaining unit 130.

The DEMUX 110 also supplies a PIT received by the previous stage to the PIT manager 140 and supplies an AIT received by the previous stage to the AIT manager 150.

### (Playback Unit 120)

The playback unit 120 plays back a set of components supplied from the component obtaining unit 130 on the basis of PITs supplied from the distribution apparatus 300A (distribution apparatuses 300A and 300B).

### (Component Obtaining Unit 130)

If necessary, the component obtaining unit 130 generates a distribution request (distribution request for a PIT, AIT, or component) to be sent to the distribution apparatus 300B, on the basis of the settings of the playback apparatus and the AIT and PIT supplied from the distribution apparatus 300A. The component obtaining unit 130 supplies the generated distribution request to the distribution apparatus 300B via the network I/F 170.

The component obtaining unit 130 also supplies a set of components supplied from the DEMUX 110 to the playback unit 120.

### (PIT Manager 140)

If the PIT supplied from the DEMUX 110 is a PIT of the latest version, the PIT manager 140 updates the PIT stored in the memory 160 to the PIT of the latest version. That is, if the PIT stored in the memory 160 is not a PIT of the latest version, the PIT manager 140 updates the PIT to the PIT of the latest version supplied from the DEMUX 110. If the PIT supplied from the DEMUX 110 is a PIT of version 00, the PIT manager 140 updates the version number (version value) of the PIT stored in the memory 160 to the same version number as the latest version number of the AIT.

### (AIT Manager 150)

If the AIT supplied from the DEMUX 110 is an AIT of the latest version, the AIT manager 150 updates the AIT stored in the memory 160 to the AIT of the latest version. That is, if the AIT stored in the memory 160 is not an AIT of the latest version, the AIT manager 150 updates the AIT to the AIT of the latest version supplied from the DEMUX 110. If the AIT supplied from the DEMUX 110 is an AIT of version 00, the AIT manager 150 updates the version number (version value) of the AIT stored in the memory 160 to the same version number as the latest version number of the PIT.

### (Memory 160)

The memory 160 is a recording medium in which a PIT and an AIT supplied to the playback unit 120 and the component obtaining unit 130 are stored. This recording medium may be another type of recording medium, such as a hard disk drive.

### (Network I/F 170)

The network I/F 170 is a communication interface used for communicating with the distribution apparatuses 300B.

### (Tuner 180)

The tuner 180 is a tuner for receiving a broadcast signal indicating, for example, a component, an AIT, and a PIT.

The configuration of the major part of the playback apparatus 100 has been discussed above.

### (Display Apparatus 200)

The display apparatus 200 displays video corresponding to a video component on a display surface (monitor) and outputs sound corresponding to an audio component from a speaker.

The configurations of the individual apparatuses included in the distribution system have been discussed above.

Details of a PIT and an AIT will be discussed below with reference to FIG. 3.

### (Details of PIT and AIT)

As described above, each of a PIT and an AIT has a version (version 00) without substantial contents and a version (version 01, version 02, . . . ) with substantial contents. The substantial contents refer to information indicating the playback mode of a component in the case of a PIT (portion surrounded by the broken lines in part (a) of FIG. 3), and refer to information indicating the location from which a component may be obtained and the specifications of the component in the case of an AIT (portion surrounded by the broken lines in part (b) of FIG. 3).

The PIT shown in part (c) of FIG. 3 is a PIT4′ (meta information) of version 00 without substantial contents, and “ver=00” in the PIT4′ describes that the component will continue to be played back on the basis of PIT4, which is the previous version with substantial contents, and that the component will continue to be obtained on the basis of AIT5, which is the latest version with substantial contents.

Similarly, the AIT shown in part (d) of FIG. 3 is a AIT5′ (meta information) of version 00 without substantial contents, and “ver=00” in the AIT5′ describes that the component will continue to be obtained on the basis of AIT5, which is the previous version with substantial contents, and that the component will continue to be played back based on the PIT4, which is the latest version with substantial contents.

The PIT4 shown in part (a) of FIG. 3 is merely a schematic illustration of the data structure of the PIT4, and specific information indicating the playback mode of the component is not shown in part (a) of FIG. 3. Similarly, the AIT5 shown in part (b) of FIG. 3 is merely a schematic illustration of the data structure of the AIT5, and specific information indicating the location from which the component may be obtained and the specifications of the component is not shown in part (b) of FIG. 3.

### (Operation of Distribution System)

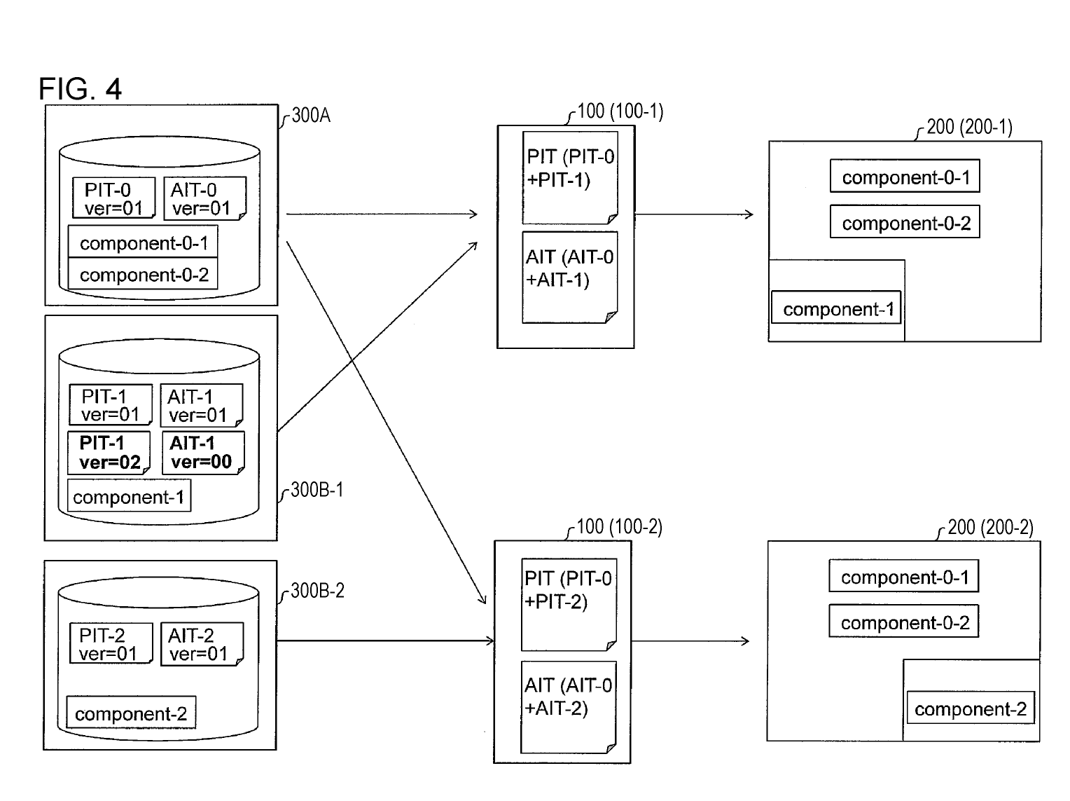

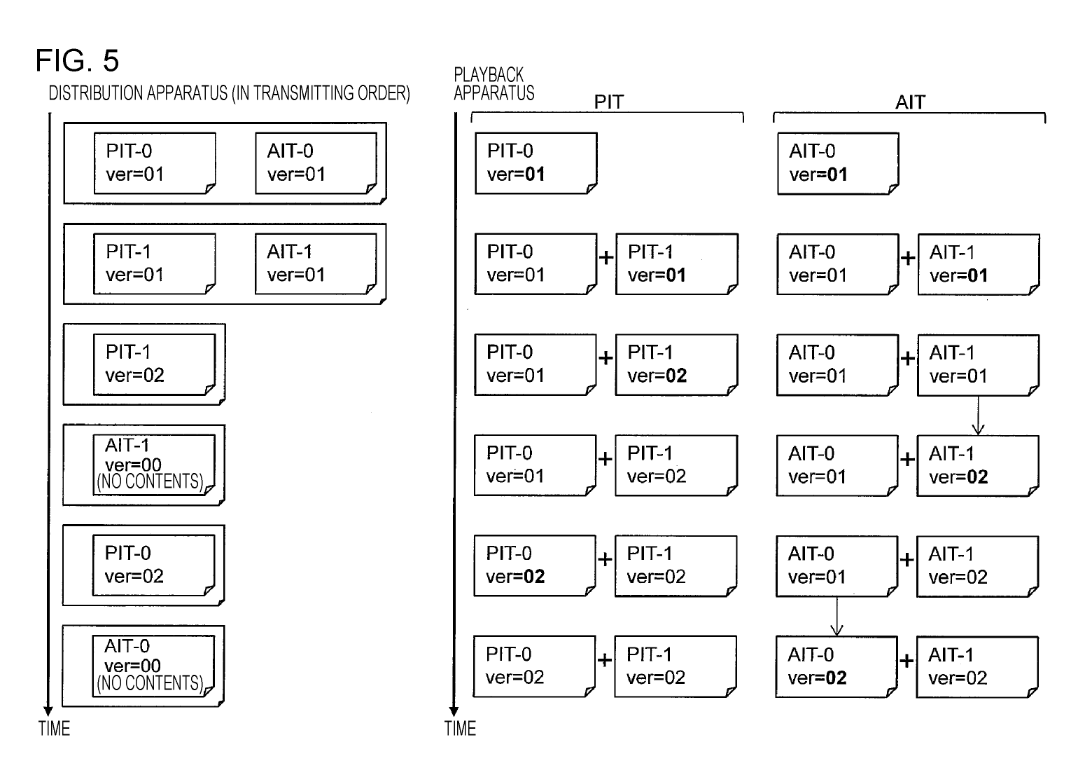

The operation of the distribution system will be described below with reference to FIGS. 4 and 5.

More specifically, the operation for playing back the same program content by two playback apparatuses 100 (playback apparatuses 100-1 and 100-2) in which different settings are set will be described.

FIG. 4 illustrates an example of a situation where a PIT and an AIT are distributed from each distribution apparatus and components are presented by the two playback apparatuses 100. FIG. 5 illustrates how the playback apparatus 100 updates a PIT and an AIT when a PIT or an AIT is updated in a distribution apparatus.

It is assumed that the playback apparatus 100-1 plays back main video, main audio, and sub video 1, but does not play back sub video 2, and that the playback apparatus 100-2 plays back main video, main audio, and sub video 2, but does not play back sub video 1. Components which will be played back and components which will not be played back may be set by a user operating the playback apparatus 100 according to the necessity. Alternatively, components which will be played back and components which will not be played back may be set in the playback apparatuses 100 in advance. It is assumed that the distribution apparatus 300A distributes components of main video and main audio, the distribution apparatus 300B-1 distributes a component of sub video 1, and the distribution apparatus 300B-2 distributes a component of sub video 2.

First, the channel in which the program content is being broadcast is selected by the two playback apparatuses 100. Then, the tuner 180 of each playback apparatus 100 receives broadcast waves from the distribution apparatus 300A. The DEMUX 110 refers to, for example, a PAT (Package Access Table), and extracts a PIT and an AIT of version 01 concerning main video and main audio and multiplexed components from the broadcast signal. Hereinafter, in this embodiment, a PIT concerning main video and main audio will be referred to as “PIT-0”, and an AIT concerning main video and main audio will be referred to as “AIT-0” according to the necessity. Similarly, a PIT concerning sub video 1 will be referred to as “PIT-1”, an AIT concerning sub video 1 will be referred to as “AIT-1”, a PIT concerning sub video 2 will be referred to as “PIT-2”, and an AIT concerning sub video 2 will be referred to as “AIT-2” according to the necessity.

In the extracted AIT-0, the packet ID of a component distributed by the distribution apparatus 300A is indicated. In the above-described PAT, the URL indicating the location from which the PIT and AIT (and components) distributed by each of the two distribution apparatuses 300B may be obtained is included. If the two distribution apparatuses 300B distribute the PIT, AIT, and components by using multicast distribution, instead of the URL, the multicast address may be included in the PAT distributed by the distribution apparatus 300A.

The DEMUX 110 supplies PIT-01 and AIT-01 of version 01 to the PIT manager 140 and the AIT manager 150, respectively.

The PIT manager 140 and the AIT manager 150 of each playback apparatus 100 respectively record the supplied PIT-0 and AIT-0 of version 01 in the memory 160.

Then, the DEMUX 110 of each playback apparatus 100 determines which components of main video and main audio will be played back by using PIT-0, on the basis of the settings of the playback apparatus 100. The DEMUX 110 also refers to the packet IDs of the components of main video and main audio indicated by AIT-0 and extracts a component of main video (“component-0-1” in FIG. 4) and a component of sub video (“component-0-2” in FIG. 4). The packet ID of each component is described in the location of the AIT shown in part (b) of FIG. 3.

Upon receiving the components of main video and main audio, the component obtaining unit 130 of the playback apparatus 100-1 sends a request to distribute PIT-1 and AIT-1 to the distribution apparatus 300B-1, on the basis of the settings of the playback apparatus 100-1. Similarly, upon receiving the components of main video and main audio, the component obtaining unit 130 of the playback apparatus 100-2 sends a request to distribute PIT-2 and AIT-2 to the distribution apparatus 300B-2, on the basis of the settings of the playback apparatus 100-2.

The component obtaining unit 130 may specify the URLs from which the PITs and AITs to be distributed by the distribution apparatuses 300B-1 and 300B-2 may be obtained in the following manner. The distribution apparatus 300A may distribute a PAT or EIT (Event Information Table) including the URLs from which PIT-1, PIT-2, AIT-1, and AIT-2 may be obtained. Then, by referring to the PAT or EIT, the component obtaining unit 130 may specify the URLs.

Upon receiving a distribution request, the distribution apparatus 300B-1 distributes the PIT-1 and AIT-1 of version 01 together to the playback apparatus 100-1. Similarly, upon receiving a distribution request, the distribution apparatus 300B-2 distributes the PIT-2 and AIT-2 of version 01 together to the playback apparatus 100-2. It is assumed that the PIT-1 of version 01 indicates the following information. The component of sub video 1 will be played back so that, among four divided regions obtained by equally dividing the display surface into four, sub video 1 may be displayed in the divided region on the bottom left. Similarly, it is assumed that the PIT-2 of version 01 indicates information that the component of sub video 2 will be played back so that sub video 2 may be displayed in the divided region on the bottom right of the four divided regions. The PIT-1 and PIT-2 of version 01 indicate the above-described information by the coordinates of the display positions or the scaling values with respect to the original video data when video is displayed.

The component obtaining unit 130 of the playback apparatus 100-1 obtains the AIT-1 and PIT-1 of version 01 from the distribution apparatus 300B-1 via the network I/F 170 and then records the AIT-1 and PIT-1 of version 01 in the memory 160. The component obtaining unit 130 then refers to the URL indicated by the AIT-1 from which the component of sub video 1 may be obtained and transmits a request to distribute this component to the distribution apparatus 300B-1.

Similarly, the component obtaining unit 130 of the playback apparatus 100-2 obtains the AIT-2 and PIT-2 of version 01 from the distribution apparatus 300B-2 via the network I/F 170 and then records the AIT-2 and PIT-2 of version 01 in the memory 160. The component obtaining unit 130 then refers to the URL indicated by the AIT-2 from which the component of sub video 2 may be obtained and transmits a request to distribute this component to the distribution apparatus 300B-2.

Upon receiving a distribution request, the distribution apparatus 300B-1 distributes the component of sub video 1 (“component-1” in FIG. 4) to the playback apparatus 100-1. Upon receiving a distribution request, the distribution apparatus 300B-2 distributes the component of sub video 2 (“component-2” in FIG. 4) to the playback apparatus 100-2.

The component obtaining unit 130 of the playback apparatus 100-1 supplies the component of sub video 1 obtained from the distribution apparatus 300B-1 via the network I/F 170 to the playback unit 120, together with the components of main video and main audio. The playback unit 120 plays back the components of main video, sub video 1, and main audio on the basis of the PIT-0 and PIT-1 of version 01, and supplies an audio signal of main audio and a video signal of main video and sub video 1 to a display apparatus 200-1.

Similarly, the component obtaining unit 130 of the playback apparatus 100-2 supplies the component of sub video 2 obtained from the distribution apparatus 300B-2 via the network I/F 170 to the playback unit 120, together with the components of main video and main audio. The playback unit 120 plays back the components of main video, sub video 2, and main audio on the basis of the PIT-0 and PIT-2 of version 01, and supplies an audio signal of main audio and a video signal of main video and sub video 2 to a display apparatus 200-2.

As a result, the main video and sub video 1 are displayed on the display surface of the display apparatus 200-1, as shown in the top right portion of FIG. 4, and main audio is output from the speaker of the display apparatus 200-1. Similarly, the main video and sub video 2 are displayed on the display surface of the display apparatus 200-2, as shown in the bottom right portion of FIG. 4, and main audio is output from the speaker of the display apparatus 200-2.

It is now assumed that, after the two playback apparatuses 100 started playing back the program content, the operation receiver 360 of the distribution apparatus 300B-1 has received an operation for updating only the version of PIT-1 (that is, an operation for creating PIT-1 of version 02). Upon receiving the operation for updating the PIT-1, PIT-1 of version 02 is created in the memory 340. The distribution apparatus 300B-1 then distributes the PIT-1 of version 02 to the playback apparatus 100-1, which is playing back the component of sub video 1, and successively distributes AIT-0 of version 00.

The operation to be performed by the playback apparatus 100-1 after the PIT-1 has been updated will be described below by changing the reference drawing to FIG. 5.

In the playback apparatus 100-1 which has received the PIT-1 of version 02, the PIT manager 140 overwrites the PIT-1 of version 01 stored in the memory 160 with the PIT-1 of version 02, as shown in FIG. 5.

Then, in the playback apparatus 100-1 which has received the AIT-1 of version 00, the AIT manager 150 checks the version number of PIT-1 stored in the memory 160. Then, as shown in FIG. 5, the AIT manager 150 overwrites the version number of AIT-1 stored in the memory 160 with the same number as the checked version number of PIT-1. In this case, the AIT-1 of version 00 is a table without any contents, and the contents of the AIT-1 which has already been stored in the memory 160 are retained as the contents of the AIT-1 of the same version number as that of the PIT-1.

Thereafter, the playback apparatus 100-1 continues to obtain a component of sub video 1 on the basis of the AIT-1 of version 02 having the same substantial contents as those of the AIT-1 of version 01, and continues to play back a component of sub video 1 in the playback mode indicated by the PIT-1 of version 02.

It is assumed, for example, that the PIT-1 of version 02 indicates the following information. The component of sub video 1 will be played back so that, among sixteen divided regions obtained by equally dividing the display surface into sixteen, sub video 1 may be displayed in the divided region on the bottom left corner. In this case, the playback apparatus 100-1 changes the playback mode of the component of sub video 1 so that the display region of sub video 1 will be changed from the bottom left region of the four divided regions into the bottom left corner of the sixteen divided regions.

It is assumed that the operation receiver 360 of the distribution apparatus 300A has thereafter received an operation for updating only the version of PIT-0 (that is, an operation for creating PIT-0 of version 02). In this case, the distribution apparatus 300A distributes the PIT-0 of version 02 via broadcast waves and successively distributes AIT-0 of version 00 via broadcast waves.

In each of the playback apparatuses 100 which have received the PIT-0 of version 02, the PIT manager 140 overwrites the PIT-0 of version 01 stored in the memory 160 with the PIT-0 of version 02, as shown in FIG. 5.

Then, in each of the playback apparatuses 100 which have received the AIT-0 of version 00, the AIT manager 150 checks the version number of the PIT-0 stored in the memory 160. Then, as shown in FIG. 5, the AIT manager 150 overwrites the version number of the AIT-0 stored in the memory 160 with the same number as the checked version number of the PIT-0. That is, in a manner similar to the above-described AIT-1, the contents of the AIT-0 which have already been stored in the memory 160 are retained as the contents of the AIT-0 of the same version number as that of the PIT-0.

Thereafter, the two playback apparatuses continue to obtain components of main video and main audio on the basis of the AIT-0 of version 02 having the same substantial contents as those of the AIT-0 of version 01, and continue to play back components of main video and main audio in the playback mode indicated by the PIT-0 of version 02.

The operation of the distribution system has been discussed above.

If, in each distribution apparatus, the operation receiver 360 has received an operation for updating both of a PIT and an AIT, the distribution apparatus distributes the PIT and AIT of the updated version together.

In this case, in the playback apparatus 100 which has received the PIT and AIT of the updated version, the PIT manager 140 overwrites the PIT of an existing version stored in the memory 160 with the PIT of the updated version. Similarly, the AIT manager 150 overwrites the AIT of an existing version stored in the memory 160 with the AIT of the updated version.

Thereafter, the playback apparatus 100 obtains and plays back components on the basis of the AIT and PIT of the updated version.

### Appendix of First Embodiment

As described above, the distribution system may include only one distribution apparatus. In this case, this distribution apparatus distributes all components forming the program content and inevitably distributes AITs indicating the locations from which all the components may be obtained and PITs indicating the playback modes of all the components.

### (Advantages of Distribution Apparatuses 300A and 300B)

As described above, the distribution apparatuses 300A and 300B are distribution apparatuses that distribute an AIT indicating the location from which at least one of components forming the program content may be obtained and a PIT indicating the playback mode of at least one of components forming the program content.

Every time both of an AIT and a PIT are updated, the distribution unit 330 of each of the distribution apparatuses 300A and 300B distributes an AIT and a PIT of the same updated version together.

Every time only an AIT (or a PIT) is updated, the distribution unit 330 distributes an AIT (or a PIT) of the updated version and also distributes a PIT (or an AIT) of version 00 indicating information that a component will continue to be played back (or obtained) on the basis of the PIT (or AIT) which is not updated.

With the above-described configuration, when the substantial contents of only an AIT (or PIT) which is being distributed has been updated, the distribution apparatus 300A or 300B forms an AIT (or a PIT) of the updated version and distributes it, but does not update the version number of the PIT (AIT). That is, the distribution apparatus 300A or 300B neither forms nor distributes PITs (AITs) having different version numbers and having the same contents. That is, if there are AITs or PITs having different version numbers, the substantial contents of such AITs or PITs are always different.

This enables a distribution source to perform the appropriate management of the version numbers of AITs and PITs.

With the above-described configuration, when the substantial contents of only an AIT (PIT) has been updated, the distribution apparatus 300A or 300B distributes an AIT (PIT) of the updated version and also distributes a PIT (AIT) of version 00 indicating that a component will continue to be obtained or played back on the basis of the PIT (AIT) of an existing version. Accordingly, since the PIT (AIT) of version 00 has no substantial contents, unnecessary information does not have to be distributed, for example, PITs (AITs) having the same contents do not have to be sent. In this case, upon receiving the PIT (AIT) of version 00 and the AIT (PIT) of version 02, each playback apparatus 100 continues to obtain or play back a component on the basis of the updated version of the received AIT (PIT) of version 02 and the PIT (AIT) of version 01 which has already been received before receiving the updated version of AIT (PIT).

Accordingly, the distribution apparatuses 300A and 300B are able to allow each viewer to view the content as intended by a provider. Then, on the basis of the received PIT (AIT) of version 00, the playback apparatus 100 is able to adjust the version number of the PIT (AIT) which has already been received to the latest version of the AIT (PIT), thereby facilitating the management of the version numbers of AITs and PITs. This also enables a distribution apparatus to explicitly inform a playback apparatus by sending a PIT or an AIT of version 00 that a component can continue to be played back or obtained by using a PIT or an AIT which has already been received. This has not been achieved by an existing distribution apparatus. In a known distribution system in which such information is not possible to send, it is not apparent for a playback apparatus whether or not a PIT or an AIT which has already been received can be used (in this case, the playback apparatus can continue to play back or obtain a component without waiting for a subsequent PIT or AIT to arrive) or whether or not a PIT or an AIT of an updated version will arrive later (in this case, the playback apparatus has to wait until the subsequent PIT or AIT arrives). The playback apparatus has to make a decision by oneself at which time point it will determine that a component can continue to be played back or obtained.

The distribution apparatuses 300A and 300B offer the following advantages. It is possible to allow each viewer to view the content as intended by a provider and to distribute AITs and PITs which are formed to implement the appropriate management of the version numbers of AITs and PITs.

### Second Embodiment

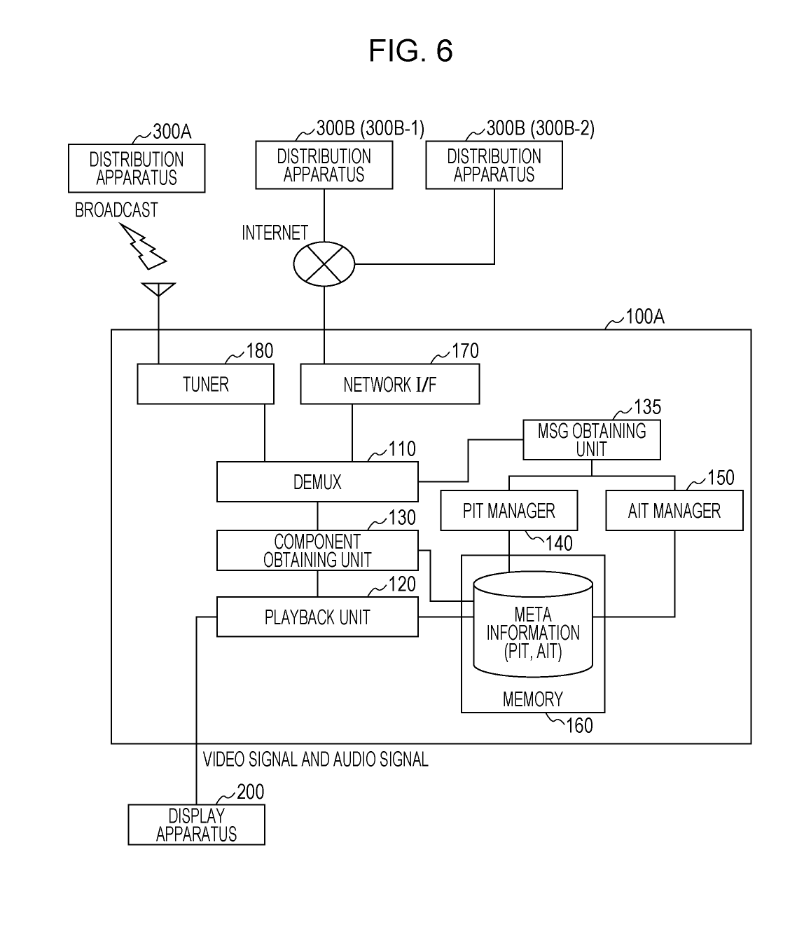

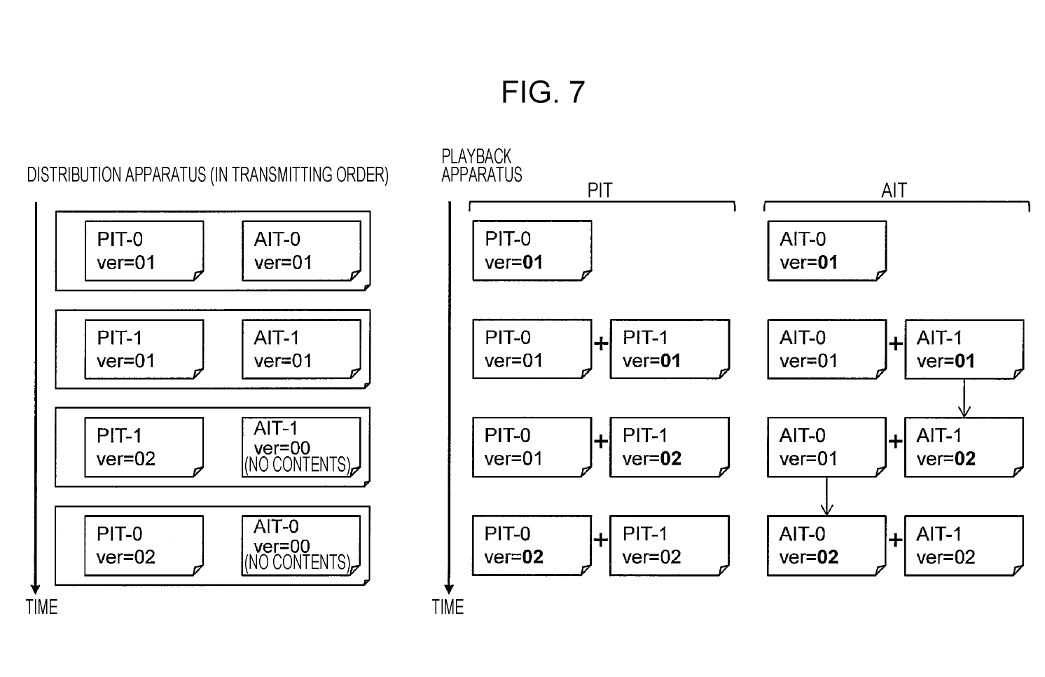

Another embodiment of the present invention will be described below with reference to FIGS. 6 and 7. For the sake of description, elements having the same functions as those of the above-described embodiment are designated by like reference numerals, and an explanation thereof will thus be omitted.

FIG. 6 illustrates a distribution system according to this embodiment and the configuration of the major part of a playback apparatus included in the distribution system according to this embodiment. FIG. 7 illustrates how the playback apparatus updates a PIT and an AIT when a PIT or an AIT is updated in a distribution apparatus included in the distribution system according to this embodiment.

In the distribution system according to this embodiment (hereinafter simply referred to as a “distribution system” in a description of this embodiment), when a PIT (AIT) is updated, a distribution apparatus distributes a container message in a predetermined format including a PIT (AIT) of the updated version and an AIT (PIT) of version 00 (hereinafter simply referred to as a “container message”).

The configuration of the distribution system will be discussed below with reference to FIG. 6.

As shown in FIG. 6, the distribution system includes a distribution apparatus 300A that performs distribution by broadcasting, two distribution apparatuses 300B (300B-1 and 300B-2) that perform distribution by communication, a playback apparatus 100A, and a display apparatus 200.

The configurations of the distribution apparatuses 300A and 300B have been discussed in the first embodiment, and an explanation thereof will thus be omitted. The configuration of the playback apparatus 100A will be discussed below.

### (Playback Apparatus 100A)

As shown in FIG. 6, the playback apparatus 100A includes an MSG obtaining unit 135 in addition to a DEMUX 110, a playback unit 120, a component obtaining unit 130, a PIT manager 140, an AIT manager 150, a memory 160, a network I/F 170, and a tuner 180. The elements other than the MSG obtaining unit 135 have been discussed in the first embodiment, and thus, a description will be given only of the MSG obtaining unit 135.

### (MSG Obtaining Unit 135)

If the playback apparatus 100A has received the above-described container message, the MSG obtaining unit 135 extracts the PIT (AIT) of the updated version and the AIT (PIT) of version 00 from the container message. The MSG obtaining unit 135 supplies the extracted PIT to the PIT manager 140 and the extracted AIT to the AIT manager 150.

### (Operation of Distribution System)

The operation for playing back the same program content by two playback apparatuses 100A (playback apparatuses 100A-1 and 100A-2) in which different settings are set will be described.

As in the first embodiment, it is assumed that the playback apparatus 100A-1 plays back main video, main audio, and sub video 1, but does not play back sub video 2, and that the playback apparatus 100A-2 plays back main video, main audio, and sub video 2, but does not play back sub video 1. It is also assumed that the distribution apparatus 300A distributes components of main video and main audio, the distribution apparatus 300B-1 distributes a component of sub video 1, and the distribution apparatus 300B-2 distributes a component of sub video 2.

As in the first embodiment, in a description of this embodiment, a PIT concerning main video and main audio will be referred to as “PIT-0”, and an AIT concerning main video and main audio will be referred to as “AIT-0” according to the necessity. Similarly, a PIT concerning sub video 1 will be referred to as “PIT-1”, an AIT concerning sub video 1 will be referred to as “AIT-1”, a PIT concerning sub video 2 will be referred to as “PIT-2”, and an AIT concerning sub video 2 will be referred to as “AIT-2” according to the necessity.

From when the channel in which the program content is being broadcast is selected until when the playback of the program content is started, the two playback apparatuses 100A perform an operation in a manner similar to the two playback apparatuses 100 discussed in the first embodiment.

It is now assumed that, after the two playback apparatuses 100A started playing back the program content, the operation receiver 360 of the distribution apparatus 300B-1 has received an operation for updating only the version of PIT-1 (that is, an operation for creating PIT-1 of version 02). Upon receiving the operation for updating the PIT-1, PIT-1 of version 02 is created in the memory 340. The distribution apparatus 300B-1 then distributes a container message including the PIT-1 of version 02 and AIT-0 of version 00 to the playback apparatus 100A-1 which is playing back the component of sub video 1.

The operation to be performed by the playback apparatus 100A-1 after the PIT-1 has been updated will be described below by changing the reference drawing to FIG. 7.

In the playback apparatus 100A-1 which has received the container message, the MSG obtaining unit 135 extracts the PIT-1 of version 02 and the AIT-1 of version 00 from the container message. At the third section of the drawing of the distribution apparatus on the left side of FIG. 7, the outer frame in the shape of a rectangle which surrounds the PIT-1 of version 02 and the AIT-1 of version 00 illustrates this container message. The MSG obtaining unit 135 supplies the PIT-1 of version 02 to the PIT manager 140 and the AIT-1 of version 00 to the AIT manager 150.

Upon receiving the PIT-1 of version 02, the PIT manager 140 overwrites the PIT-1 of version 01 stored in the memory 160 with the PIT-1 of version 02, as shown in FIG. 7. Meanwhile, upon receiving the AIT-1 of version 00, the AIT manager 150 checks the version number of PIT-1 stored in the memory 160, and overwrites the version number of AIT-1 stored in the memory 160 with the same number as the checked version number of PIT-1, as shown in FIG. 7.

Thereafter, the playback apparatus 100A-1 continues to obtain a component of sub video 1 on the basis of the AIT-1 of version 02 having the same substantial contents as those of the AIT-1 of version 01, and continues to play back a component of sub video 1 in the playback mode indicated by the PIT-1 of version 02.

It is assumed that the operation receiver 360 of the distribution apparatus 300A has thereafter received an operation for updating only the version of PIT-0 (that is, an operation for creating PIT-0 of version 02). In this case, the distribution apparatus 300A distributes a container message including the PIT-0 of version 02 and AIT-0 of version 00 (container message indicated in the fourth section of the drawing of the distribution apparatus on the left side of FIG. 7) via broadcast waves.

In each of the two playback apparatuses 100A which have received the container message, the MSG obtaining unit 135 extracts the PIT-0 of version 02 and AIT-0 of version 00 from the container message. The MSG obtaining unit 135 then supplies the PIT-0 of version 02 to the PIT manager 140 and the AIT-0 of version 00 to the AIT manager 150.

Upon receiving the PIT-0 of version 02, the PIT manager 140 overwrites the PIT-0 of version 01 stored in the memory 160 with the PIT-0 of version 02, as shown in FIG. 7. Meanwhile, upon receiving the AIT-0 of version 00, the AIT manager 150 checks the version number of PIT-0 stored in the memory 160, and overwrites the version number of AIT-0 stored in the memory 160 with the same number as the checked version number of PIT-0, as shown in FIG. 7.

Thereafter, the two playback apparatuses continue to obtain components of main video and main audio on the basis of the AIT-0 of version 02 having the same substantial contents as those of the AIT-0 of version 01, and continue to play back components of main video and main audio in the playback mode indicated by the PIT-0 of version 02.

The operation of the distribution system has been discussed above. As is seen from the foregoing description, the distribution apparatuses 300A and 300B according to this embodiment achieve advantages similar to those of the distribution apparatuses 300A and 300B according to the first embodiment. In addition to the above-described advantages, this embodiment offers the following advantage. Since a PIT and an AIT associated with each other are stored and distributed in a container message, special processing, such as correcting of asynchronization between a PIT and an AIT, is not necessary.

### Third Embodiment

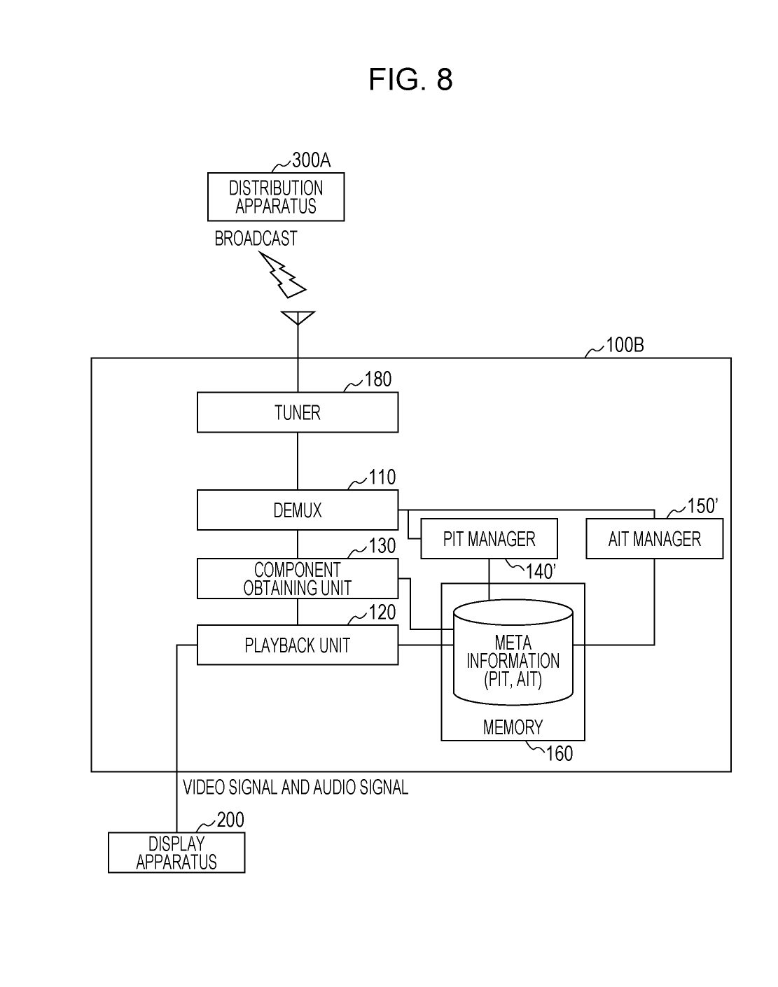

Still another embodiment of the present invention will be described below with reference to FIGS. 8 through 11. For the sake of description, elements having the same functions as those of the above-described embodiments are designated by like reference numerals, and an explanation thereof will thus be omitted.

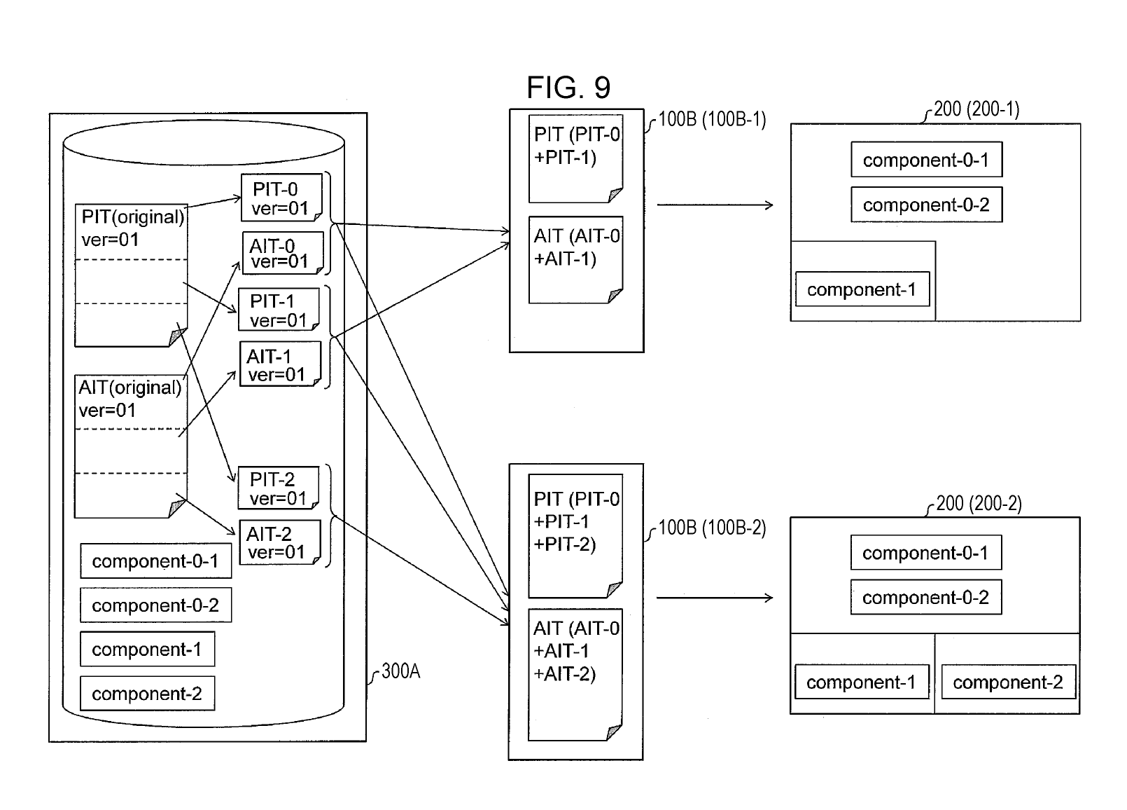

FIG. 8 illustrates a distribution system according to this embodiment and the configuration of the major part of a playback apparatus included in the distribution system according to this embodiment. FIG. 9 illustrates an example of a situation where a PIT and an AIT of the initial version are distributed from a distribution apparatus included in the distribution system according to this embodiment and components are presented by the above-described playback apparatus.

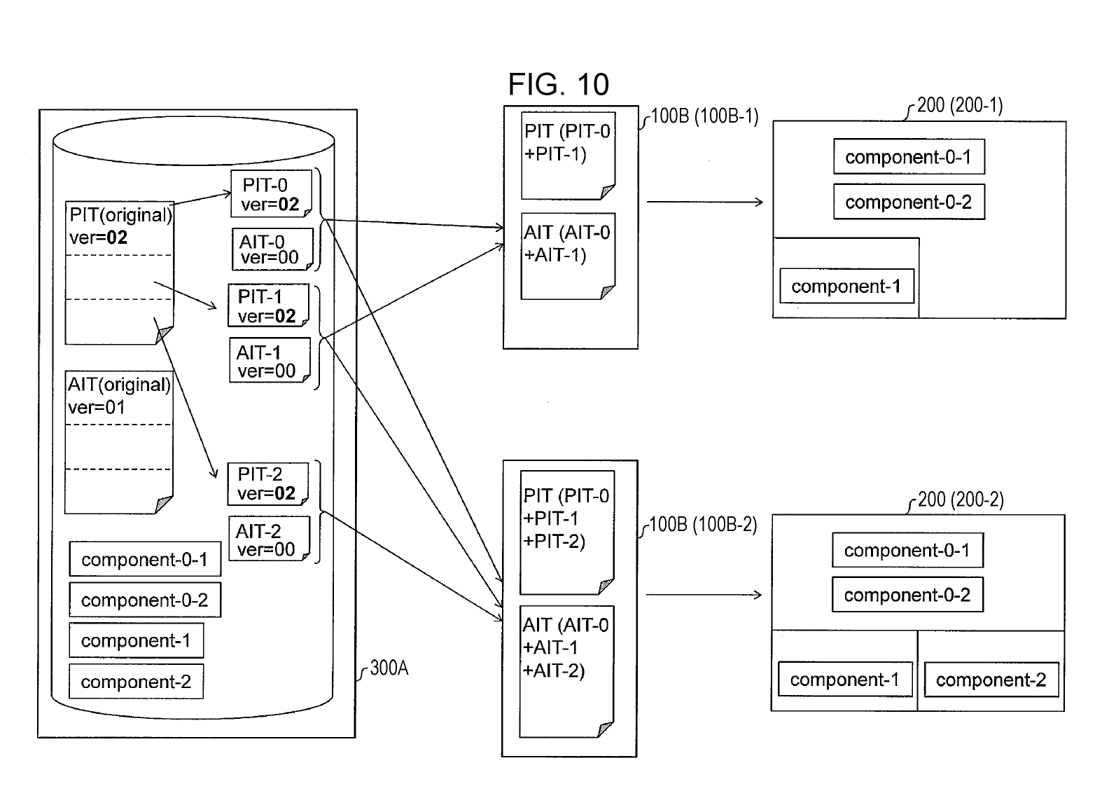

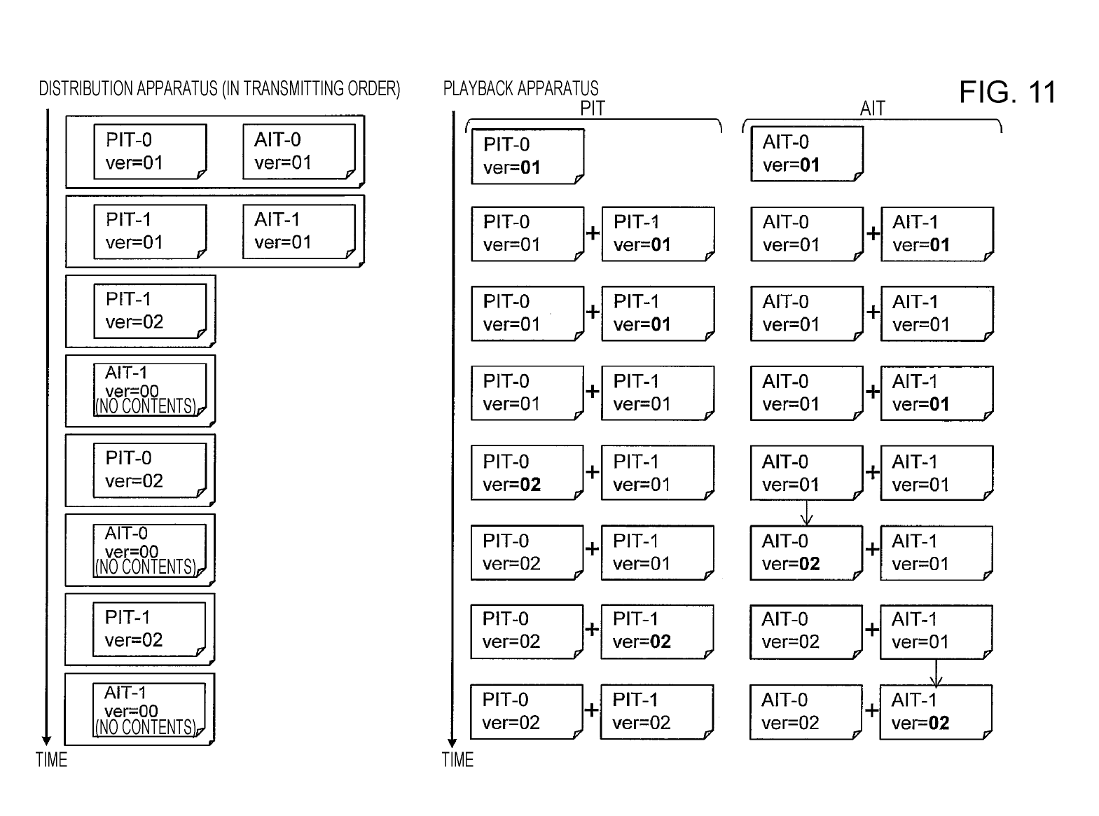

FIG. 10 illustrates an example of a situation where, immediately after a PIT is updated for the first time, PITs and AITs are distributed from the distribution apparatus and components are presented by the playback apparatuses. FIG. 11 illustrates how the playback apparatus updates a PIT and an AIT when a PIT or an AIT is updated in the distribution apparatus included in the distribution system according to this embodiment.

In the distribution system according to this embodiment, a set of components forming program content are distributed via multiple layers (base layer, enhancement layer 1, which is higher than the base layer, and enhancement layer 2, which is higher than the enhancement layer 1). That is, the distribution system according to this embodiment supports multilayer transport.

The playback apparatus is configured in the following manner. Only while the playback apparatus is playing back a component distributed via the base layer, is it able to play back a component distributed via the enhancement layer 1. More specifically, only while the playback apparatus is playing back a component distributed via the base layer on the basis of a PIT of version number i, is it able to play back a component distributed via the enhancement layer 1 on the basis of the PIT of version number i.

Similarly, the playback apparatus is configured in the following manner. Only while the playback apparatus is playing back a component distributed via the enhancement layer 1, is it able to play back a component distributed via the enhancement layer 2. More specifically, only while the playback apparatus is playing back a component distributed via the enhancement layer 1 on the basis of a PIT of version number i, is it able to play back a component distributed via the enhancement layer 2 on the basis of the PIT of version number i.

The reason why the playback apparatus is configured as described above in this embodiment is that, for example, it is substantially impossible to interpret a component distributed via an enhancement layer unless a component distributed via a lower layer is used together (for example, a component subjected to scalable coding). There may also be another reason, for example, for the purpose of imposing restrictions on the playback apparatus so that video in a mode which is not intended by a provider will not be displayed on a display apparatus. The video in a mode which is not intended by a provider includes video constituted only by main video and sub video 2 from which sub video 1 is arbitrarily omitted and video played back by arbitrarily combining sub video 1 transmitted in the past and main video transmitted later.

In this embodiment, in an AIT (hereinafter may also be referred to as an “original AIT”), the location (packet ID) from which a component may be obtained via each of the base layer, enhancement layer 1, and enhancement layer 2 is indicated. Similarly, in a PIT (hereinafter may also be referred to as an “original PIT”), the playback mode of a component distributed via each of the base layer, enhancement layer 1, and enhancement layer 2 is indicated. Hereinafter, according to the necessity, a PIT concerning main video and main audio distributed via the base layer will be referred to as “PIT-0”, and an AIT concerning main video and main audio distributed via the base layer will be referred to as “AIT-0”. Similarly, a PIT concerning sub video 1 distributed via the enhancement layer 1 will be referred to as “PIT-1”, and an AIT concerning sub video 1 distributed via the enhancement layer 1 will be referred to as “AIT-1”. Similarly, a PIT concerning sub video 2 distributed via the enhancement layer 2 will be referred to as “PIT-2”, and an AIT concerning sub video 2 distributed via the enhancement layer 2 will be referred to as “AIT-2”.

In the distribution system according to this embodiment (hereinafter simply referred to as a “distribution system” in a description of this embodiment), every time a version of the original PIT is generated (updated), the distribution apparatus divides the generated (updated) original PIT so as to generate PIT-0, PIT-1, and PIT-2. The distribution apparatus then distributes the generated PIT-0, PIT-2, and PIT-2 via broadcast waves. The distribution apparatus also performs similar processing for AIT.

The configuration of the distribution system will be described below with reference to FIG. 8.

As shown in FIG. 8, the distribution system includes a distribution apparatus 300A that performs distribution by broadcasting, a playback apparatus 100B, and a display apparatus 200.

The configuration of the distribution apparatus 300A has been discussed in the first embodiment, and an explanation thereof will thus be omitted. The configuration of the playback apparatus 100B will be described below.

### (Playback Apparatus 100B)

As shown in FIG. 8, the playback apparatus 100B includes a DEMUX 110, a playback unit 120, a component obtaining unit 130, a PIT manager 140′, an AIT manager 150′, a memory 160, and a tuner 180. The elements other than the PIT manager 140′ and the AIT manager 150′ have been discussed in the first embodiment, and thus, a description will be given only of the PIT manager 140′ and the AIT manager 150′.

### (PIT Manager 140′)

If the PIT-0 supplied from the DEMUX 110 is a PIT-0 of the latest version, the PIT manager 140′ updates the PIT-0 stored in the memory 160 to the PIT-0 of the latest version. That is, if the PIT-0 stored in the memory 160 is not a PIT-0 of the latest version, the PIT manager 140′ updates the PIT-0 to the PIT-0 of the latest version supplied from the DEMUX 110.

If the PIT supplied from the DEMUX 110 is a PIT-1 of the latest version concerning the enhancement layer 1, the PIT manager 140′ updates the PIT-1 stored in the memory 160 to the PIT-1 of the latest version only when the following condition is satisfied. More specifically, only when the condition that the version number of the PIT-1 of the latest version is the same as the version numbers of the PITs (in this example, PIT-0) of all higher layers stored in the memory 160 is satisfied, does the PIT manager 140′ update the PIT-1 to the PIT-1 of the latest version. That is, the PIT manager 140′ replaces the PIT-1 stored in the memory 160 by the PIT-1 of the latest version. The PIT manager 140′ performs similar processing when the PIT supplied from the DEMUX 110 is a PIT-2 of the latest version concerning the enhancement layer 2. In this case, PITs of all higher layers are PIT-0 and PIT-1.

If the PIT supplied from the DEMUX 110 is a PIT-0 of version 00, the PIT manager 140′ updates the version number of the PIT-0 stored in the memory 160 to the same number as the latest version number of the AIT-0. If the PIT supplied from the DEMUX 110 is a PIT-1 or PIT-2 of version 00, the PIT manager 140′ performs similar processing according to the necessity. Since the above-described condition has been applied to the associated AIT-1 and AIT-2, the PIT manager 140′ does not update the version of PIT-1 or PIT-2 unless the version of AIT-1 or AIT-2 has been updated.

### (AIT Manager 150′)

If the AIT supplied from the DEMUX 110 is an AIT-0 of the latest version, the AIT manager 150′ updates the AIT-0 stored in the memory 160 to the AIT-0 of the latest version. That is, if the AIT-0 stored in the memory 160 is not an AIT-0 of the latest version, the AIT manager 150′ updates the AIT-0 to the AIT-0 of the latest version supplied from the DEMUX 110.

If the AIT supplied from the DEMUX 110 is an AIT-1 of the latest version concerning the enhancement layer 1, the AIT manager 150′ updates the AIT-1 stored in the memory 160 to the AIT-1 of the latest version only when the following condition is satisfied. More specifically, only when the version number of the AIT-1 of the latest version is the same as the version numbers of the AITs (in this example, AIT-0) of all higher layers stored in the memory 160, does the AIT manager 150′ update the AIT-1 to the AIT-1 of the latest version. That is, the AIT manager 150′ replaces the AIT-1 stored in the memory 160 by the AIT-1 of the latest version. The AIT manager 140′ performs similar processing when the AIT supplied from the DEMUX 110 is an AIT-2 of the latest version concerning the enhancement layer 2. In this case, AITs of all higher layers are AIT-0 and AIT-1.

If the AIT supplied from the DEMUX 110 is an AIT-0 of version 00, the AIT manager 150′ updates the version number of the AIT-0 stored in the memory 160 to the same number as the latest version number of the PIT-0. If the AIT supplied from the DEMUX 110 is an AIT-1 or AIT-2 of version 00, the AIT manager 150′ performs similar processing according to the necessity. Since the above-described condition has been applied to the associated PIT-1 and PIT-2, the AIT manager 150′ does not update the version of AIT-1 or AIT-2 unless the version of PIT-1 or PIT-2 has been updated, in a manner similar to the PIT manager 140′.

The configuration of the distribution system has been discussed above.

### (Operation of Distribution System)

The operation of the distribution system will be described below with reference to FIGS. 9 through 11.

More specifically, the operation for playing back the same program content by two playback apparatuses 100B (playback apparatuses 100B-1 and 100B-2) in which different settings are set will be described.

It is assumed that the playback apparatus 100B-1 plays back main video, main audio, and sub video 1, but does not play back sub video 2, and that the playback apparatus 100B-2 plays back main video, main audio, sub video 1, and sub video 2. The distribution apparatus 300A distributes components of main video, main audio, sub video 1, and sub video 2.

First, the channel in which the program content is being broadcast is selected by the two playback apparatuses 100B. Then, the tuner 180 of each playback apparatus 100B receives broadcast waves from the distribution apparatus 300A. Then, the DEMUX 110 refers to a PAT and extracts PITs and AITs of version 01 and multiplexed components from the broadcast signal. More specifically, the DEMUX 110 extracts PITs and AITs according to the settings of the playback apparatus 100B. For example, the DEMUX 110 of the playback apparatus 100B-1 extracts PIT-0, PIT-1, AIT-0, and AIT-1, while the DEMUX 110 of the playback apparatus 100B-2 extracts PIT-0, PIT-1, PIT-2, AIT-0, AIT-1, and AIT-2.

In each of the extracted AITs, the packet ID of a component distributed via the layer corresponding to the extracted AIT is indicated.

The DEMUX 110 of each playback apparatus 100B refers to the packet IDs of the components of main video and main audio indicated by AIT-0, and extracts a main video component (“component-0-1” in FIG. 9) and a main audio component (“component-0-2” in FIG. 9) from the multiplexed components, on the basis of the settings of the playback apparatus 100B. Similarly, the DEMUX 110 refers to the packet ID of the component of sub video 1 indicated by AIT-1 and extracts the component of sub video 1 (“component-1” in FIG. 9) from the multiplexed components.

In addition to the above-described operation, the DEMUX 110 of the playback apparatus 100B-2 refers to the packet ID of the component of sub video 2 indicated by AIT-2 and extracts the component of sub video 2 (“component-2” in FIG. 9) from the multiplexed components, on the basis of the settings of the playback apparatus 100B-2.

The DEMUX 110 also supplies each of the extracted PITs of version 01 to the PIT manager 140′ and each of the extracted AITs of version 01 to the AIT manager 150′.

The PIT manager 140 and the AIT manager 150 of each playback apparatus 100B respectively record each of the supplied PITs and each of the supplied AITs of version 01 in the memory 160.

The DEMUX 110 of each playback apparatus 100B supplies each of the extracted components to the component obtaining unit 130.

The component obtaining unit 130 of the playback apparatus 100B-1 supplies the components of main video, sub video 1, and main audio obtained from the distribution apparatus 300A to the playback unit 120, on the basis of the settings of the playback apparatus 300B-1. The playback unit 120 plays back the components of main video, sub video 1, and main audio on the basis of the PIT-0 and PIT-1 of version 01, and supplies the audio signal of main audio and the video signal of main video and sub video 1 to a display apparatus 200-1.

Similarly, the component obtaining unit 130 of the playback apparatus 100B-2 supplies the components of main video, sub video 1, sub video 2, and main audio obtained from the distribution apparatus 300A to the playback unit 120, on the basis of the settings of the playback apparatus 100B-2. The playback unit 120 plays back the components of main video, sub video 1, sub video 2, and main audio on the basis of the PIT-0, PIT-1, and PIT-2 of version 01, and supplies the audio signal of main audio and the video signal of main video, sub video 1, and sub video 2 to a display apparatus 200-1.

As a result, the main video and sub video 1 are displayed on the display surface of the display apparatus 200-1, as shown in the top right portion of FIG. 9, and main audio is output from the speaker of the display apparatus 200-1. Similarly, the main video, sub video 1, and sub video 2 are displayed on the display surface of the display apparatus 200-2, as shown in the bottom right portion of FIG. 9, and main audio is output from the speaker of the display apparatus 200-2.

It is now assumed that, after the two playback apparatuses 100 started playing back the program content, the operation receiver 360 of the distribution apparatus 300A has received an operation for updating only the version of the original PIT (that is, an operation for creating an original PIT of version 02). Upon receiving the operation for updating the original PIT, the original PIT of version 02 is created in the memory 340, as shown in the left side of FIG. 10.

Then, as shown in FIG. 10, the distribution apparatus 300A divides the original PIT of version 02 so as to generate PIT-0, PIT-1, and PIT-2 of version 02. Thereafter, PITs distributed from the distribution apparatus 300A will be PITs of version 02, and AITs distributed from the distribution apparatus 300A will be AITs of version 00 stored in the memory 340 in advance.

The operation to be performed by the playback apparatus 100B-1 after the original PIT has been updated will be described below by changing the reference drawing to FIG. 11.

It is assumed that the playback apparatus 100B-1 has first received PIT-1 of version 02 (third section in FIG. 11). In the playback apparatus 100B-1 which has received the PIT-1 of version 02, the PIT manager 140′ checks the version of the PIT-0 stored in the memory 160. Since the version of the PIT-0 stored in the memory 160 is not the version 02, the PIT manager 140′ discards the PIT-1 of version 02 without updating the PIT-1 of version 01 stored in the memory 160, as shown in FIG. 11.

In the playback apparatus 100B-1 which has successively received AIT-1 of version 00 (fourth section in FIG. 11), the AIT manager 150′ checks the version number of PIT-1 stored in the memory 160. Since the version number of PIT-1 stored in the memory 160 is the same as the version number of AIT-1, the AIT manager 150′ does not overwrite the version number of AIT-1 stored in the memory 160, as shown in FIG. 11.

It is assumed that the playback apparatus 100B-1 has thereafter received PIT-0 of version 02 (fifth section in FIG. 11). In the playback apparatus 100B-1 which has received the PIT-0 of version 02, the PIT manager 140′ overwrites the PIT-0 of version 01 stored in the memory 160 with the PIT-0 of version 02, as shown in FIG. 11.

In the playback apparatus 100B-1 which has successively received AIT-0 of version 00 (sixth section in FIG. 11), the AIT manager 150′ checks the version number of PIT-0 stored in the memory 160. Then, the AIT manager 150′ overwrites the version number of AIT-0 stored in the memory 160 with the same number as the checked version number of PIT-0, as shown in FIG. 11.

It is assumed that the playback apparatus 100B-1 has thereafter received the PIT-1 of version 02 once again. In the playback apparatus 100B-1 which has received the PIT-1 of version 02, the PIT manager 140′ checks the version of PIT-0 stored in the memory 160. Since the version of PIT-0 stored in the memory 160 is the version 02, the PIT manager 140′ overwrites the PIT-1 of version 01 stored in the memory 160 with the PIT-1 of version 02, as shown in FIG. 11.

In the playback apparatus 100B-1 which has successively received the AIT-1 of version 00 once again, the AIT manager 150′ checks the version number of PIT-1 stored in the memory 160. Then, the AIT manager 150′ overwrites the version number of AIT-1 stored in the memory 160 with the same number as the checked version number of PIT-1, as shown in FIG. 11.

The operation of the distribution system has been discussed above. As is seen from the foregoing description, the distribution apparatus 300A according to this embodiment achieves advantages similar to those of the distribution apparatus 300A according to the first embodiment. In addition to the above-described advantages, this embodiment offers the following advantage. The distribution apparatus 300A according to this embodiment is able to control the playback operation of the playback apparatus 100B for playing back the program content which will be distributed by multilayer transport so that video will be displayed on the display apparatus 200 in a mode intended by the provider.

### Fourth Embodiment

Still another embodiment of the present invention will be described below.

A distribution system according to this embodiment is a system which supports multilayer transport, as in the distribution system according to the third embodiment. However, the distribution system of this embodiment is different from that of the third embodiment.

That is, the distribution system according to this embodiment is able to distribute program content by utilizing one of the following two methods in accordance with the contents of the program content (at provider's discretion).

Method 1: performing hybrid transport for distributing program content by using both broadcasting and communication so that a playback apparatus can play back a component of each layer independently

Method 2: performing multilayer transport for distributing program content by broadcasting so that a playback apparatus is unable to play back a component of a higher layer unless it plays back a component of a lower layer (similar to a distribution method used by the distribution system according to the third embodiment)

If a provider wishes or allows that a playback apparatus may independently play back each component forming the program content, the program content is distributed by hybrid transport (method 1). On the other hand, if a provider does not allow a playback apparatus to independently play back each component forming the program content, the program content is distributed by multilayer transport (method 2).

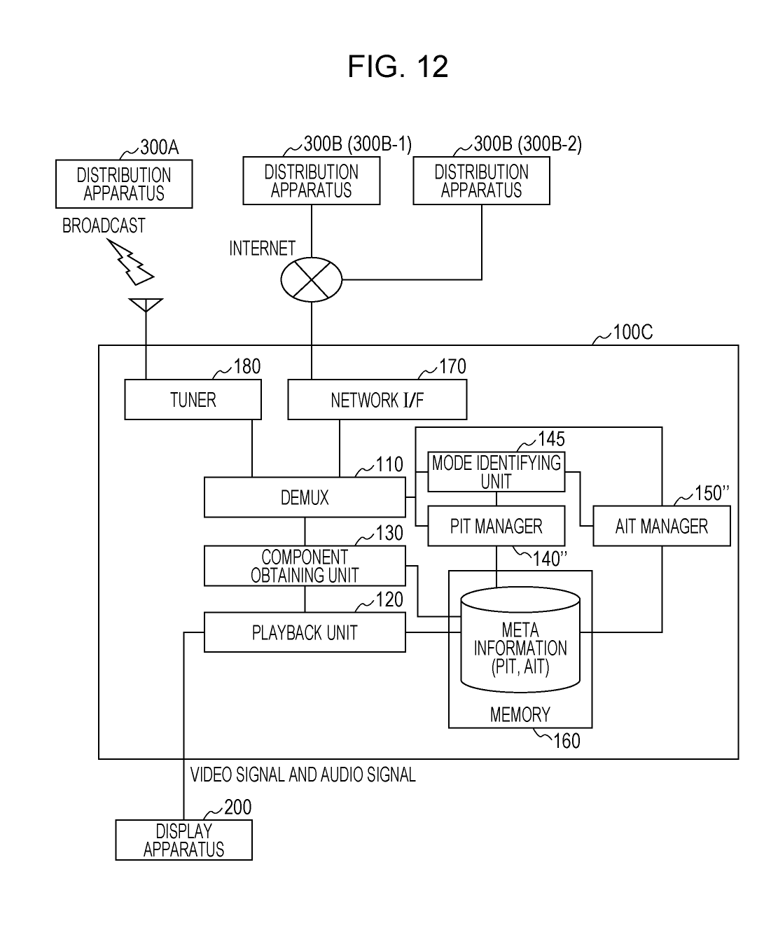

This embodiment will be described below with reference to FIGS. 12 through 14. For the sake of description, elements having the same functions as those of the above-described embodiments are designated by like reference numerals, and an explanation thereof will thus be omitted.

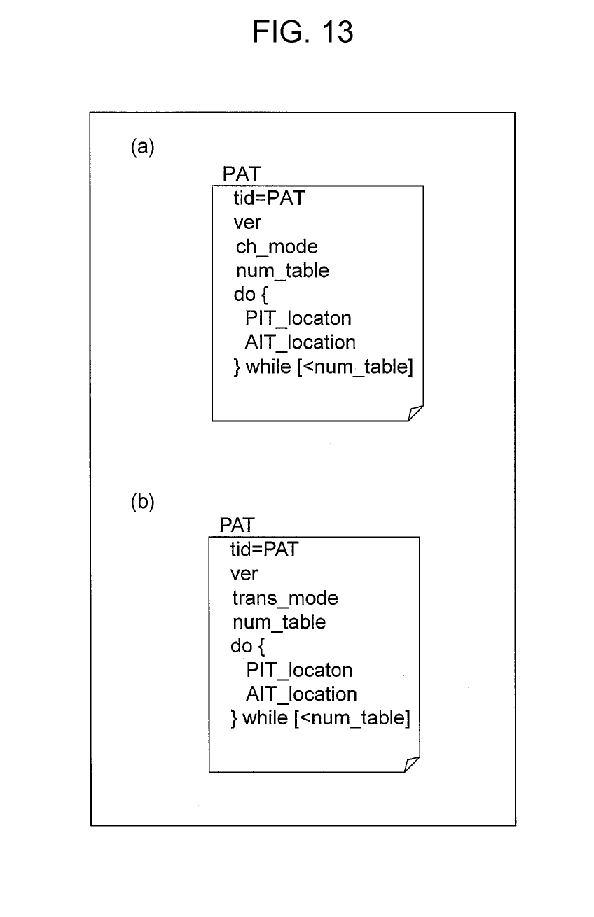

FIG. 12 illustrates a distribution system according to this embodiment and the configuration of the major part of a playback apparatus included in the distribution system according to this embodiment. FIG. 13 schematically illustrates examples of the data structures of PATs (meta data) concerning program content and indicating whether the program content will be distributed by using the method 1 or the method 2 and also indicating the locations from which a PIT and an AIT may be obtained. Part (a) of FIG. 13 illustrates an example of a PAT used for switching between multichannel transport and multilayer transport (single-channel transport), and part (b) of FIG. 13 illustrates an example of a PAT used for switching between hybrid transport and multilayer transport (single-channel transport).

In FIG. 13, “tid=PAT” indicates the type of table, “ver” indicates the version number, “trans_mode” is an identifier indicating whether or not the transport mode is hybrid transport, and “ch_mode” is an identifier whether or not the transport mode is multichannel transport mode. When each of “trans_mode” and “ch_mode” is “1”, it represents the hybrid transport or multichannel transport mode. When each of “trans_mode” and “ch_mode” is “0”, it represents the multilayer transport mode. In FIG. 13, “num_table” indicates the total number of PITs and AITs, and “PIT_location” and “AIT_location” respectively indicate the locations (packet IDs or URLs) from which PITs and AITs may be obtained.

In the multichannel-transport PAT shown in part (a) of FIG. 13, information concerning the locations from which PITs for the number of channels used for broadcasting may be obtained is indicated. Similarly, information concerning the locations from which AITs for the number of channels used for broadcasting may be obtained is indicated. Accordingly, the value of “num_table” is basically equal to the value expressed by (the number of channels×2). However, multichannel transport without PITs is also possible, in which case, the value of “num_table” is equal to the number of channels. On the other hand, in the hybrid-transport PAT shown in part (b) of FIG. 13, information concerning the locations from which PITs for the number of distribution sources using broadcasting or communication may be obtained is indicated. Similarly, information concerning the locations from which AITs as the number of distribution sources using broadcasting or communication may be obtained is indicated. Accordingly, the value of “num_table” is basically equal to the value expressed by (the number of distribution sources×2). However, PATs in a hierarchical structure may be possible, such as that each distribution source forms a PAT, and thus, the value of “num_table” is not simply determined. Except for this point, there is basically no difference between the PAT shown in part (a) of FIG. 13 and the PAT shown in part (b) of FIG. 13. Accordingly, “subset_mode”, which indicates whether layers are dependent on each other or are independent (the value “1” indicates that the layers are dependent on each other and the value “0” indicates that the layers are independent) may be defined, and “subset_mode” may be described in the PAT, instead of “trans_mode” and “ch_mode”.

Multichannel transport shown in part (a) of FIG. 13 will be discussed later in a modified example of this embodiment.

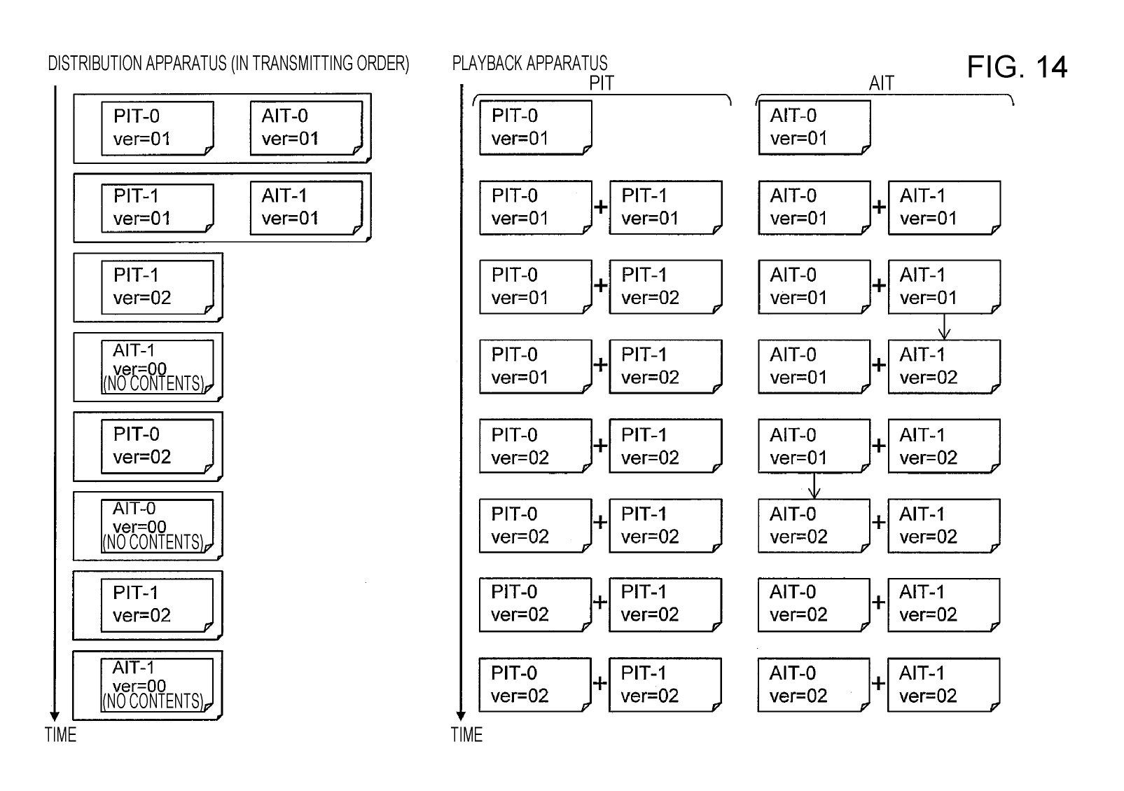

FIG. 14 illustrates how the playback apparatus updates a PIT and an AIT when a PIT or an AIT is updated in the distribution system of this embodiment while program content is being transmitted by hybrid transport.

A distribution apparatus 300A is able to distribute the PAT (Package Access Table) shown in part (b) of FIG. 13 via broadcast waves, together with an AIT, a PIT, and multiplexed components.

In this embodiment, in an AIT distributed from the distribution apparatus 300A while the program content is being distributed by multilayer transport, the location (packet ID) from which a component to be distributed via a corresponding layer may be obtained is indicated. Similarly, in a PIT distributed from the distribution apparatus 300A while the program content is being distributed by multilayer transport, the playback mode of a component to be distributed via a corresponding layer is indicated.

In this embodiment, in an AIT distributed from the distribution apparatus 300A while the program content is being distributed by hybrid transport, the location (packet ID) from which a component of each of main video and main audio may be obtained is indicated. In an AIT distributed from a distribution apparatus 300B-1 while the program content is being distributed by hybrid transport, the location (URL) from which a component of sub video 1 may be obtained is indicated. Similarly, in an AIT distributed from a distribution apparatus 300B-2 while the program content is being distributed by hybrid transport, the location (URL) from which a component of sub video 2 may be obtained is indicated.

Similarly, in a PIT distributed from the distribution apparatus 300A while the program content is being distributed by hybrid transport, the playback mode of a component of each of main video and main audio is indicated. In a PIT distributed from the distribution apparatus 300B-1 while the program content is being distributed by hybrid transport, the playback mode of a component of sub video 1 is indicated. Similarly, in a PIT distributed from the distribution apparatus 300B-2 while the program content is being distributed by hybrid transport, the playback mode of a component of sub video 2 is indicated.

Hereinafter, a PIT concerning main video and main audio will be referred to as “PIT-0”, and an AIT concerning main video and main audio will be referred to as “AIT-0” according to the necessity. Similarly, a PIT concerning sub video 1 will be referred to as “PIT-1”, and an AIT concerning sub video 1 will be referred to as “AIT-1”.

The configuration of the distribution system will be described below with reference to FIG. 12.

As shown in FIG. 12, the distribution system includes a distribution apparatus 300A that performs distribution by broadcasting, two distribution apparatuses 300B (300B-1 and 300B-2) that perform distribution by communication, a playback apparatus 100C, and a display apparatus 200.

The configurations of the distribution apparatuses 300A and 300B have been discussed in the first embodiment, and an explanation thereof will thus be omitted. The configuration of the playback apparatus 100C will be discussed below.

### (Playback Apparatus 100C)

As shown in FIG. 12, the playback apparatus 100C includes a DEMUX 110, a playback unit 120, a component obtaining unit 130, a PIT manager 140″, a MODE identifying unit 145, an AIT manager 150″, a memory 160, a network I/F 170, and a tuner 180.

The elements other than the PIT manager 140″, the MODE identifying unit 145, and the AIT manager 150″ have been discussed in the first embodiment, and thus, a description will be given only of the PIT manager 140″, the MODE identifying unit 145, and the AIT manager 150″.

### (MODE Identifying Unit 145)

The MODE identifying unit 145 refers to the PAT shown in part (b) of FIG. 13 and determines whether the program content will be distributed by using the method 1 (hybrid transport) or the method 2 (multilayer transport). More specifically, if the value of the trans mode identifier of the PAT in part (b) of FIG. 13 is “1” (“hybrid mode”), the MODE identifying unit 145 determines that the program content will be distributed by using the method 1. If the value of the trans mode identifier of the PAT in part (b) of FIG. 13 is “0” (“multilayer mode”), the MODE identifying unit 145 determines that the program content will be distributed by using the method 2.

### (PIT Manager 140″)

If it is determined that the program content will be distributed by using the method 1, the PIT manager 140″ performs processing similar to that performed by the PIT manager 140. If it is determined that the program content will be distributed by using the method 2, the PIT manager 140″ performs processing similar to that performed by the PIT manager 140′.

### (AIT Manager 150″)

If it is determined that the program content will be distributed by using the method 1, the AIT manager 150″ performs processing similar to that performed by the AIT manager 150. If it is determined that the program content will be distributed by using the method 2, the AIT manager 150″ performs processing similar to that performed by the AIT manager 150′.

The configuration of the distribution system has been discussed above.

### (Operation of Distribution System)

The operation of the distribution system will be described below with reference to FIGS. 13 and 14. It is assumed that the playback apparatus 100C does not play back a component of layer 2 distributed from the distribution apparatus 300B-2.

First, the channel in which the program content is being broadcast is selected by the playback apparatus 100C. Then, the tuner 180 receives broadcast waves from the distribution apparatus 300A. Then, the DEMUX 110 extracts a PAT (Package Access Table) from the broadcast waves, and supplies the PAT to the MODE identifying unit 145 and the component obtaining unit 130. Additionally, the DEMUX 110 refers to the values of PIT location and AIT location (packet IDs) in the PAT and extracts the PIT and AIT of version 01 from the broadcast signal and also extracts multiplexed components from the broadcast signal.

More specifically, if it is determined by the MODE identifying unit 145 that the program content will be distributed by using the method 1, the DEMUX 110 extracts a PIT (specifically, PIT-0) and an AIT (specifically, AIT-0) of version 01. In contrast, if it is determined by the MODE identifying unit 145 that the program content will be distributed by using the method 2, the DEMUX 110 extracts PITs (specifically, PIT-0 and PIT-1) and AITs (specifically, AIT-0 and AIT-1) of version 01, on the basis of the settings of the playback apparatus 100C.

The DEMUX 110 refers to the packet ID of each of the components indicated by the extracted AIT of version 01 and extracts the components from the multiplexed components.

The DEMUX 110 also supplies the extracted PIT of version 01 to the PIT manager 140″ and the extracted AIT of version 01 to the AIT manager 150″.

The PIT manager 140″ and the AIT manager 150″ respectively record the supplied PIT and the supplied AIT of version 01 in the memory 160.

The DEMUX 110 supplies each of the extracted components to the component obtaining unit 130.

The component obtaining unit 130 supplies each of the components obtained from the distribution apparatus 300A to the playback unit 120. If it is determined by the MODE identifying unit 145 that the program content will be distributed by using the method 1, the component obtaining unit 130 sequentially performs the following step 1 through step 4.

Step 1) The component obtaining unit 130 refers to the above-described PAT indicating the URLs of the PIT-1 and AIT-1 of version 01 (the values of PIT_location and AIT_location), and obtains the PIT-1 and AIT-1 of version 01 from the distribution apparatus 300B-1, on the basis of the settings of the playback apparatus 100C.

Step 2) The component obtaining unit 130 records the PIT-1 and AIT-1 of version 01 obtained from the distribution apparatus 300B-1 in the memory 160.

Step 3) The component obtaining unit 130 obtains the component of layer 1 from the distribution apparatus 300B-1, on the basis of the AIT-1 of version 01.

Step 4) The component obtaining unit 130 supplies the obtained component of layer 1 to the playback unit 120.

The playback unit 120 plays back the received components on the basis of the PIT-0 and PIT-1 of version 01 recorded in the memory 160, and supplies the corresponding video signal and audio signal to the display apparatus 200.

A description will be given below of the operation to be performed by the playback apparatus 100C when a PIT is updated in a distribution source after the playback of program content has started. This will be discussed for each of a case in which the program content will be distributed by using the method 1 and a case in which the program content will be distributed by using the method 2.

(Case in which Program Content will be Distributed by using Method 1)

It is assumed that an operation for updating PIT-0 has been performed in the distribution apparatus 300A and that an operation for updating PIT-1 has been performed in the distribution apparatus 300B-1. In this case, the PIT which will be thereafter distributed by the distribution apparatus 300A is PIT-0 of version 02, and the AIT which will be thereafter distributed by the distribution apparatus 300A is AIT-0 of version 00 stored in the memory 340 in advance. Similarly, the PIT which will be thereafter distributed by the distribution apparatus 300B-1 is PIT-1 of version 02, and the AIT which will be thereafter distributed by the distribution apparatus 300B-1 is AIT-1 of version 00 stored in the memory 340 in advance.

After the PITs have been updated, the playback apparatus 100C performs processing similar to that performed by the playback apparatus 100 of the first embodiment, on the basis of the determination result of the MODE identifying unit 145.

It is assumed, for example, that the playback apparatus 100C has received PIT-1 of version 02 for the first time after the original PIT has been updated. In this case, in the playback apparatus 100C, the PIT manager 140″ overwrites the PIT-1 of version 01 stored in the memory 160 with the PIT-1 of version 02, as shown in FIG. 14, on the basis of the determination result of the MODE identifying unit 145.

In the playback apparatus 100C which has successively received AIT-1 of version 00, the AIT manager 150″ checks the version number of PIT-1 stored in the memory 160. Then, the AIT manager 150″ overwrites the version number of AIT-1 stored in the memory 160 with the same number as the checked version number of PIT-1, as shown in FIG. 14.

It is assumed the playback apparatus 100C has then received PIT-0 of version 02. In this case, in the playback apparatus 100C, the PIT manager 140″ overwrites the PIT-0 of version 01 stored in the memory 160 with the PIT-0 of version 02, as shown in FIG. 14, on the basis of the determination result of the MODE identifying unit 145.

In the playback apparatus 100C which has successively received AIT-0 of version 00, the AIT manager 150″ checks the version number of PIT-0 stored in the memory 160. Then, the AIT manager 150″ overwrites the version number of AIT-0 stored in the memory 160 with the same number as the checked version number of PIT-0, as shown in FIG. 14.

(Case in which Program Content will be Distributed by using Method 2)

When the operation receiver 360 of the distribution apparatus 300A has received an operation for updating only the original PIT, the distribution apparatus 300A divides the original PIT of version 02 so as to generate PIT-0, PIT-1, and PIT-2 of version 02. The PITs which will be thereafter distributed by the distribution apparatus 300A are PITs of version 02, and AITs which will be thereafter distributed by the distribution apparatus 300A are AITs of version 00 stored in the memory 340 in advance.

After the original PIT has been updated, the playback apparatus 100C performs processing similar to that performed by the playback apparatus 100B of the third embodiment after the original PIT has been updated, on the basis of the determination result of the MODE identifying unit 145.

It is assumed, for example, that the playback apparatus 100C has received PIT-1 of version 02 for the first time after the original PIT has been updated. In this case, in the playback apparatus 100C which has received PIT-1 of version 02, the PIT manager 140″ checks the version of PIT-0 stored in the memory 160, on the basis of the determination result of the MODE identifying unit 145. Since the version of the PIT-0 stored in the memory 160 is not the version 02, the PIT manager 140″ discards the PIT-1 of version 02 without updating the PIT-1 of version 01 stored in the memory 160, as shown in FIG. 11.

The operation of the distribution system has been discussed above. As is seen from the foregoing description, the distribution apparatuses 300A and 300B according to this embodiment also achieve advantages similar to those of the distribution apparatuses 300A and 300B according to the first embodiment. In addition to the above-described advantages, this embodiment offers the following advantage. Regardless of whether program content is distributed by multilayer transport or hybrid transport, the distribution apparatuses according to this embodiment are able to control the playback operation of the playback apparatus 100C for playing back the program content so that video will be displayed on the display apparatus 200 in a mode intended by the provider.

As is seen from the foregoing description, a PAT used in the distribution system according to this embodiment may be considered as meta information indicating that the playback apparatus 100C is allowed to independently play back a component of each layer.

### Modified Example of Fourth Embodiment

The distribution system according to the fourth embodiment may be a system that distributes program content only by broadcasting, as in the distribution system according to the second embodiment, and that distributes program content by multilayer transport, as in the distribution system according to the third embodiment. This system (distribution system according to this modified example) will be described below.

The distribution system according to this modified example is able to distribute program content by utilizing one of the following two methods in accordance with the contents of the program content (at provider's discretion).

Method 1: performing multilayer transport (multichannel transport) for distributing program content by using broadcasting so that a playback apparatus can play back a component of each layer (each channel (group)) independently

Method 2: performing multilayer transport (single-channel transport) for distributing program content by broadcasting so that a playback apparatus is unable to play back a component of a higher layer unless it plays back a component of a lower layer

The configuration of the distribution system according to this modified example is similar to that of the distribution system shown in FIG. 8. The configurations of a distribution apparatus and a playback apparatus according to this modified example are respectively similar to those of the distribution apparatus 300A and the playback apparatus 100C, but they are respectively different from those of the distribution apparatus 300A and the playback apparatus 100C in the following points.

The distribution apparatus according to this modified example distributes the PAT shown in part (a) of FIG. 13 instead of the PAT shown in part (b) of FIG. 13.

The MODE identifying unit of the playback apparatus according to this modified example refers to the PAT shown in part (a) of FIG. 13 and determines whether the program content will be distributed by using the method 1 (multichannel transport) or the method 2 (single-channel transport). More specifically, if the value of the ch_mode identifier of the PAT in part (a) of FIG. 13 is “1” (“multichannel mode”), the MODE identifying unit 145 determines that the program content will be distributed by using the method 1. If the value of the ch_mode identifier of the PAT in part (a) of FIG. 13 is “0” (“single-channel mode”), the MODE identifying unit 145 determines that the program content will be distributed by using the method 2.

The distribution apparatus according to this modified example also achieves advantages similar to those of the distribution apparatuses 300A and 300B according to the first embodiment. In addition to the above-described advantages, this modified example offers the following advantage. Regardless of whether or not program content is distributed by multichannel transport, the distribution apparatus according to this modified example is able to control the playback operation of the playback apparatus 100C for playing back the program content so that video will be displayed on the display apparatus 200 in a mode intended by the provider.

### Appendix 1 of Fourth Embodiment

Instead of distributing a mode identifier by including it in a PAT, the distribution apparatus may distribute a mode identifier by the following approaches.

For example, the distribution apparatus may distribute a mode identifier (such as a trans mode identifier or a ch_mode identifier) by including it in a PIT-i and/or AIT-i. In this case, by referring to the PIT-i or AIT-i received by the playback apparatus, the MODE identifying unit of the playback apparatus is able to determine whether the program content will be distributed by using the method 1 or the method 2.

Alternatively, if a message including a PIT and an AIT is distributed, the distribution apparatus may distribute a mode identifier by including it in this message. In this case, by referring to this message received by the playback apparatus, the MODE identifying unit of the playback apparatus is able to determine whether the program content will be distributed by using the method 1 or the method 2. In this case, since a PIT and an AIT related to each other are distributed together, the transport mode corresponding to the PIT and AIT is considered to be the same. By including a mode identifier in a message including a PIT and an AIT, a situation where the same information is described in both of the PIT and the AIT can be avoided.

Alternatively, the distribution apparatus may distribute a mode identifier by including it in a PA message (Package Access message), which is different from a message including a PIT and an AIT described above. The PA message is a message to be distributed by storing a PAT (Package Access Table) described above therein. In this case, by referring to the PA message received by the playback apparatus, the MODE identifying unit of the playback apparatus is able to determine whether the program content will be distributed by using the method 1 or the method 2.

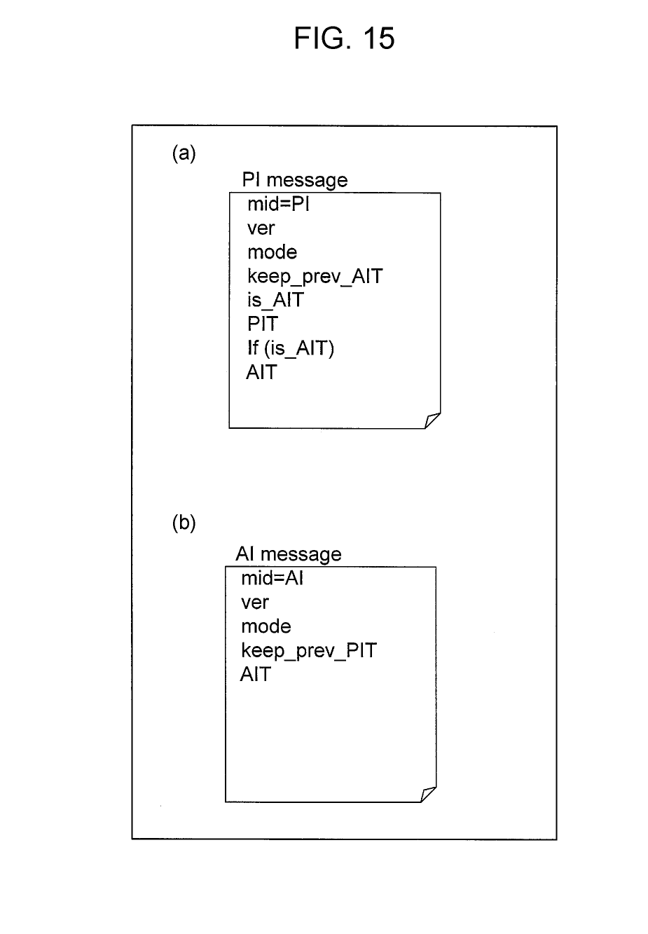

Instead of distributing a mode identifier by including it in a PAT, the distribution apparatus may distribute a mode identifier by including it in a PI message and/or an AI message, as shown in FIG. 15. FIG. 15 illustrates examples of the data structures of a PI message and an AI message. In FIG. 15, “mid=PI” and “mid=AI” indicate the type of message, “ver” indicates the version number, and “mode” indicates the mode identifier.

The PI message is a message for transmitting a PIT and an AIT together, while the AI message is a message for transmitting an AIT alone. If a PIT is transmitted alone, the PI message is used, in which case, “is_AIT” shown in FIG. 15 is set to be 0 (“false”).

In this case, by referring to “mode” described in the PI message or the AI message received by the playback apparatus, the MODE identifying unit of the playback apparatus is able to determine whether the program content will be distributed by using the method 1 or the method 2. In FIG. 15, “mode” may be either one of “trans_mode” and “ch_mode”. Alternatively, “mode” may be the same as “subset_mode” which indicates whether layers are dependent on each other or are independent (the value “1” indicates that the layers are dependent on each other and the value “0” indicates that the layers are independent) described above.

### (Appendix 1)

The distribution apparatus according to each of the first through fourth embodiments may distribute a keep_prev_PIT flag by including it in an AI message, as shown in FIG. 15, instead of distributing a PIT of version 00 (PIT-0, PIT-1, . . . ). Similarly, the distribution apparatus according to each of the first through fourth embodiments may distribute a keep_prev_AIT flag by including it in a PI message, as shown in FIG. 15, instead of distributing an AIT of version 00 (AIT-0, AIT-2, AIT-2 . . . ).

The keep_prev_AIT flag included in a PI message is a flag indicating that only the version number of the AIT stored in the playback apparatus will be updated without changing the substantial contents. That is, the “keep_prev_AIT” flag described in the PI message shown in part (a) of FIG. 15 is a flag indicating that there will be no change to the AIT associated with the PIT stored in the message (that the AIT of the existing version will continue to be used), and is a flag having a function equivalent to the AIT of version 00 discussed in, for example, the first embodiment. Instead of storing the AIT of version 00 in the PI message, this flag is used and the flag value “1” indicates that there will be no change to the AIT. Similarly, the keep_prev_PIT flag included in an AI message is a flag indicating that only the version number of the PIT stored in the playback apparatus will be updated without changing the substantial contents. That is, the “keep_prev_PIT” flag described in the AI message shown in part (b) of FIG. 15 is a flag similar to the “keep_prev_AIT” flag and indicates that there will be no change to the PIT associated with the AIT stored in the message (that the PIT of the existing version will continue to be used).

If the distribution apparatus of an embodiment (any embodiment among the first through fourth embodiments) is configured as described above, the playback apparatus is configured in the following manner. Upon receiving an AI message, the playback apparatus performs processing similar to that performed by the playback apparatus of a corresponding embodiment which has received a PIT of version 00. Moreover, upon receiving a PI message, the playback apparatus performs processing similar to that performed by the playback apparatus of a corresponding embodiment which has received an AIT of version 00.

Instead of describing a flag, another approach may be employed. For example, concerning a PIT stored in the playback apparatus, a dedicated message (Hold_PI message) indicating that only the version number of the PIT will be updated without changing the substantial contents may be defined. Similarly, concerning an AIT stored in the playback apparatus, a dedicated message (Hold_AI message) indicating that only the version number of the AIT will be updated without changing the substantial contents may be defined. Then, by using such messages, an instruction to update the PIT or AIT may be provided to the playback apparatus.

Instead of distributing a PIT (PIT-0, PIT-1, . . . ) of version 00 together with an AIT of the latest version, the distribution apparatus according to each of the first through fourth embodiments may create a PIT of the same version number as that of this AIT and distribute the PIT. In this case, the distribution apparatus creates a PIT only including a table type, a version number, and specified information (for example, a character string “isStayed”) without including the substantial contents (information concerning the playback mode). Then, upon receiving a PIT including the above-described specified information, the playback apparatus performs processing similar to that performed by the playback apparatus of a corresponding embodiment which has received a PIT of version 00.

Similarly, instead of distributing an AIT (AIT-0, AIT-1, . . . ) of version 00 together with a PIT of the latest version, the distribution apparatus according to each of the first through fourth embodiments may create an AIT of the same version number as that of this PIT and distribute the AIT. In this case, the distribution apparatus creates an AIT only including a table type, a version number, and specified information (for example, a character string “isStayed”) without including the substantial contents (information concerning the location from which a component may be obtained). Then, upon receiving an AIT including the above-described specified information, the playback apparatus performs processing similar to that performed by the playback apparatus of a corresponding embodiment which has received an AIT of version 00.

### (Appendix 2)

Each of the distribution apparatuses (300A, 300B) of the first and second embodiments may distribute a PIT and an AIT of the same version by including them in a container message. Each of the distribution apparatuses may also distribute information indicating the transmission time of a container message or a sequence number by including it in the container message. Each of the distribution apparatuses (300A, 300B) of the first embodiment may also distribute information indicating the transmission time of a PIT and an AIT which are not included in a container message or a sequence number by including it in the PIT and the AIT.

The PIT manager 140 of each of the playback apparatuses (100, 100A) of the first and second embodiments may perform processing for PITs in order of the transmission time or the sequence number, instead of the order in which PITs are supplied to the PIT manager 140. Similarly, the AIT manager 150 of each of the playback apparatuses (100, 100A) of the first and second embodiments may perform processing for AITs in order of the transmission time or the sequence number, instead of the order in which AITs are supplied to the AIT manager 150.

### (Appendix 3)

In the first, third, and fourth embodiments, each of the distribution apparatuses (distribution apparatuses 300A, 300B-1, and 300B-2) distributes an AIT and a PIT concerning a component distributed by the corresponding distribution apparatus among all components forming video content. However, the present invention is not restricted to this configuration.

The main distribution apparatus (distribution apparatus 300A) may distribute AITs concerning all components including components which are not distributed by the main distribution apparatus, and each of the distribution apparatuses may distribute a PIT concerning a component distributed by the corresponding distribution apparatus. Alternatively, the main distribution apparatus may distribute PITs concerning all components including components which are not distributed by the main distribution apparatus, and each of the distribution apparatuses may distribute an AIT concerning a component distributed by the corresponding distribution apparatus.

[Implementation Example using Software]

Control blocks (in particular, the playback unit 120, the component obtaining unit 130, the MSG obtaining unit 135, the PIT manager (140, 140′, 140″), the MODE identifying unit 145, and the AIT unit (150, 150′, 150″)) of the playback apparatus 100 (100A, 100B, 100C) and/or control blocks (in particular, the distribution unit 330) of the distribution apparatus (300A, 300B) may be implemented by a logic circuit (hardware) formed on, for example, an integrated circuit (IC chip), or may be implemented by software using a CPU (Central Processing Unit).

If the control blocks are implemented by software, the playback apparatus and/or the distribution apparatus include a CPU that executes commands of a program, which is software implementing the individual functions, a ROM (Read Only Memory) or a storage device (which will be referred to as a “recording medium”) on which the above-described program and various items of data are recorded so that they are readable by a computer (or a CPU), and a RAM (Random Access Memory) that loads the above-described program therein. Then, as a result of a computer (or a CPU) reading the above-described program from the recording medium and executing it, the objects of the present invention are achieved. As the above-described recording medium, a “non-transitory tangible medium”, such as tape, a disk, a card, a semiconductor memory, or a programmable logic circuit, may be used. The above-described program may be supplied to the computer via a certain transmission medium (such as a communication network or broadcast waves) through which the program is transmittable. The present invention may also be realized in the form of a data signal embedded in a carrier wave in which the above-described program is implemented through digital transmission.

### SUMMARY

A distribution apparatus (distribution apparatus 300A) according to a first aspect of the present invention is a distribution apparatus for distributing configuration information (AIT5) indicating a location from which at least one of components forming content is obtained and composition information (PIT4) indicating a playback mode of the at least one of components. The distribution apparatus includes a first distributor (distribution unit 330) that distributes the configuration information and the composition information of an identical version and a second distributor (distribution unit 330) that distributes, in a case in which only one of the configuration information and the composition information of the identical version is updated, an updated version of one of the configuration information and the composition information (AIT5 of version 02 (PIT4 of version 02)) which is updated, and also distributes information (PIT4′ (AIT5′)) indicating that the least one of components will continue to be obtained or played back on the basis of the other one of the configuration information and the composition information (AIT4 of version 01 (PIT5 of version 01)).

With the above-described configuration, when the substantial contents (for example, the location from which a component may be obtained) of only one of the configuration information and the composition information of the identical version is updated, the distribution apparatus distributes the updated version of one of the configuration information and the composition information which is updated, but does not update the version of the other one of the configuration information and the composition information. That is, if the version number of an item of configuration information or composition information is different from that of another item of configuration information or composition information, the substantial contents of such items of configuration information or composition information are always different.

This enables a distribution source to perform the appropriate management of the version numbers of configuration information and composition information.

With the above-described configuration, when the substantial contents (for example, the location from which a component may be obtained) of only one of configuration information and composition information is updated, the distribution apparatus distributes the updated version of one of the configuration information and the composition information which is updated and also distributes information indicating that the component will continue to be obtained or played back on the basis of the other one of the configuration information and the composition information. Accordingly, upon receiving this information and the updated version of one of the configuration information and the composition information, each playback apparatus continues to obtain or play back the component on the basis of the received updated version of one of the configuration information and the composition information and the other one of the configuration information and the composition information which has already been received before receiving the updated version.

Accordingly, the distribution apparatus is able to allow each viewer to view the content as intended by a provider.

The distribution apparatus according to the first aspect of the present invention offers the following advantages. It is possible to allow each viewer to view the content as intended by a provider and to distribute configuration information and composition information which are formed to implement the appropriate management of the version numbers of the configuration information and the composition information.

According to a second aspect of the present invention, in the distribution apparatus according to the first aspect, the first distributor may distribute a container message including the configuration information and the composition information of the identical version.

According to a third aspect of the present invention, in the distribution apparatus according to the first or second aspect, the second distributor may distribute, in a case in which only one of the configuration information and the composition information is updated, a container message including an updated version of one of the configuration information and the composition information which is updated, and including information indicating that the at least one of components will continue to be obtained or played back on the basis of the other one of the configuration information and the composition information.

According to a fourth aspect of the present invention, in the distribution apparatus according to one of the first through third aspects, the content may be constituted by a plurality of components, and each of the plurality of components may belong to one of a plurality of specified groups (layers, channels). Concerning each of the plurality of groups, the first distributor may distribute the configuration information and the composition information of an identical version concerning a component belonging to a corresponding group. The distribution apparatus may further include a third distributor (distribution unit 330) that distributes meta information (for example, AIT, PIT, PAT, PI message, and AI message) indicating whether or not the components are allowed to be played back independently according to the group.

According to a fifth aspect of the present invention, in the distribution apparatus according to one of the first through third aspects, the content may be constituted by a plurality of components. The distribution apparatus may further include a multilayer transporter (distribution unit 330) that distributes the plurality of components by multilayer transport. The multilayer transporter may transport each of the plurality of components via a base layer or an enhancement layer. Concerning each of the base layer and the enhancement layer, the first distributor may distribute the configuration information and the composition information of an identical version concerning a component transported via the base layer or the enhancement layer.

A playback apparatus (playback apparatus 100) according to a sixth aspect of the present invention is a playback apparatus for obtaining and playing back at least one of components forming content on the basis of configuration information indicating a location from which the at least one of components is obtained and composition information indicating a playback mode of the at least one of components. The playback apparatus includes: an obtainer (component obtaining unit 130, PIT manager 140, AIT manager 150) that obtains the configuration information and the composition information of an identical version; an updater (PIT manager 140, AIT manager 150) that updates, upon obtaining an updated version of one of the configuration information and the composition information and information indicating that the at least one of components will continue to be obtained or played back on the basis of the other one of the configuration information and the composition information, a version value of the other one of the configuration information and the composition information to a value identical to a version value of the obtained updated version; and a player (playback unit 120) that plays back a component which is obtained on the basis of the configuration information of a latest version, on the basis of the composition information of a version identical to the latest version of the configuration information.

With the above-described configuration, if the distribution apparatus according to the first aspect of the present invention distributes configuration information and composition information of the same version, the above-described obtainer obtains the configuration information and the composition information of the same version.

With the above-described configuration, if the distribution apparatus according to the first aspect of the present invention distributes an updated version of one of the configuration information and the composition information and information indicating that the component will continue to be obtained or played back on the basis of the other one of the configuration information and the composition information, and if the playback apparatus obtains the above-described updated version and the above-described information, the updater updates the version value of the other one of the configuration information and the composition information to the same value as the version value of the obtained updated version.

Then, the player plays back a component which is obtained on the basis of the configuration information of a latest version, on the basis of the composition information of the same version as the latest version of the configuration information.

Accordingly, the playback apparatus according to the sixth aspect of the present invention achieves the advantage of playing back the content on the basis of configuration information and composition information distributed from the distribution apparatus according to the first aspect of the present invention.

According to a seventh aspect of the present invention, in the playback apparatus according to the sixth aspect, the content may be constituted by a plurality of components, and each of the plurality of components may belong to one of a plurality of specified groups (channels, layers). Concerning each of the plurality of groups, the obtainer may obtain the configuration information and the composition information of an identical version concerning a component belonging to a corresponding group. In a case in which the playback apparatus has received meta information (for example, AIT, PIT, PAT, PI message, and AI message including a flag value representing multichannel transport) indicating that the components are allowed to be played back independently according to the group, the updater may update, every time an updated version of one of the configuration information and the composition information and information indicating that the component will continue to be obtained or played back on the basis of the other one of the configuration information and the composition information are obtained, the version value of the other one of the configuration information and the composition information to a value identical to the version value of the obtained updated version.

According to an eighth aspect of the present invention, in the playback apparatus according to the sixth aspect, the content may be constituted by a plurality of components, and each of the plurality of components may be a component distributed via a base layer or an enhancement layer. Concerning each of the base layer and the enhancement layer, the obtainer may obtain the configuration information and the composition information of an identical version concerning a component transported via the base layer or the enhancement layer. Upon obtaining an updated version of one of the configuration information and the composition information concerning the enhancement layer and information indicating that the component will continue to be obtained or played back on the basis of the other one of the configuration information and the composition information, the updater may update the version value of the other one of the configuration information and the composition information to a value identical to the version value of the obtained updated version only when the version value of the configuration information and the composition information concerning the base layer is the same as the version value of the updated version.

A distribution system according to a ninth aspect of the present invention is a distribution system including a playback apparatus and a distribution apparatus. The distribution apparatus may be the distribution apparatus according to claim 1 and the playback apparatus may be the playback apparatus according to claim 6.

A distribution method according to a tenth aspect of the present invention is a distribution method for a distribution apparatus for distributing configuration information indicating a location from which at least one of components forming content is obtained and composition information indicating a playback mode of the at least one of components. The distribution method includes a first distributing step of distributing the configuration information and the composition information of an identical version and a second distributing step of distributing, in a case in which only one of the configuration information and the composition information is updated, an updated version of one of the configuration information and the composition information which is updated and also distributing information indicating that the least one of components will continue to be obtained or played back on the basis of the other one of the configuration information and the composition information.

With the above-described configuration, the distribution method according to the tenth aspect of the present invention achieves advantages similar to those of the distribution apparatus according to the first aspect of the present invention.

A playback method according to an eleventh aspect of the present invention is a playback method for a playback apparatus for obtaining and playing back at least one of components forming content on the basis of configuration information indicating a location from which the at least one of components is obtained and composition information indicating a playback mode of the at least one of components. The playback method includes: an obtaining step of obtaining the configuration information and the composition information of an identical version; an updating step of updating, upon obtaining an updated version of one of the configuration information and the composition information and information indicating that the at least one of components will continue to be obtained or played back on the basis of the other one of the configuration information and the composition information, a version value of the other one of the configuration information and the composition information to a value identical to a version value of the obtained updated version; and a playing step of playing back a component which is obtained on the basis of the configuration information of a latest version, on the basis of the composition information of a version identical to the latest version of the configuration information.

With the above-described configuration, the playback method according to the eleventh aspect of the present invention achieves advantages similar to those of the playback apparatus according to the sixth aspect of the present invention.

The distribution apparatus according to each aspect of the present invention may be implemented by using a computer. In this case, a distribution program for causing a computer to operate as the first and second distributors included in the distribution apparatus so as to implement the distribution apparatus by using the computer, and a computer-readable recording medium for recording the distribution program therein are also encompassed within the present invention.

Similarly, the playback apparatus according to each aspect of the present invention may be implemented by using a computer. In this case, a playback program for causing a computer to operate as the obtainer, the updater, and the player included in the playback apparatus so as to implement the playback apparatus by using the computer, and a computer-readable recording medium for recording the playback program therein are also encompassed within the present invention.

Meta data is distributed every time only one of configuration information indicating a location from which at least one of components forming content is obtained and composition information indicating a playback mode of the at least one of components is updated. The meta data is provided to a playback apparatus which is obtaining or playing back the at least one of components on the basis of the other one of the configuration information and the composition information and which has received one of the configuration information and the composition information which is updated. The meta data indicates that the playback apparatus will continue to obtain or play back the at least one of components on the basis of the other one of the configuration information and the composition information. Such meta data is also encompassed within the present invention.

The present invention is not restricted to the above-described embodiments, and various modifications and changes may be made within the scope of the claims. Embodiments obtained by suitably combining technical means disclosed in the different embodiments are also encompassed within the technical scope of the present invention. Further, by suitably combining technical means disclosed in the embodiments, novel technical features may be formed.

### INDUSTRIAL APPLICABILITY

The present invention may be suitably used in a content distribution service.

### REFERENCE SIGNS LIST

100 playback apparatus

120 playback unit (player)

130 component obtaining unit (obtainer)

135 MSG obtaining unit

140 PIT manager (obtainer, updater)

145 MODE identifying unit (obtainer, updater)

150 AIT manager

300A distribution apparatus

330 distribution unit (first distributor, second distributor, third distribution, multilayer transporter)

1-9. (canceled)

10. A distribution apparatus for distributing one or more components forming content, the distribution apparatus comprising:
a distributor that distributes configuration information and composition information, wherein the configuration information indicates a location from which the one or more components is obtained and the composition information indicates a playback mode of the one or more components;
wherein the distributor distributes one of the configuration information and the composition information, and also distributes information indicating that the one or more components will continue to be obtained or played back on the basis of the other one of the configuration information and the composition information which has already been obtained.

11. The distribution apparatus according to claim 10, wherein, in a case in which only one of the configuration information and the composition information is updated, the distributor distributes an updated version of one of the configuration information and the composition information which is updated.

12. A playback apparatus for playing back one or more components forming content, the playback apparatus comprising:
an obtainer that obtains configuration information and composition information, wherein the configuration information indicates a location from which the one or more components is obtained and the composition information indicates a playback mode of the one or more components;
a player that performs a playback operation on the basis of the configuration information and the composition information; and
an updater that updates, upon obtaining one of the configuration information and the composition information and information indicating that the one or more components will continue to be obtained or played back on the basis of the other one of the configuration information and the composition information which has already been obtained, the obtained one of the configuration information and the composition information by using the obtained information and updates both of the configuration information and the composition information to a latest version,
wherein the player plays back a component which is obtained on the basis of the configuration information of the latest version, on the basis of the composition information of the latest version.

13. The playback apparatus according to claim 12, wherein:
upon obtaining one of the configuration information and the composition information and information indicating that the one or more components will continue to be obtained or played back on the basis of the other one of the configuration information and the composition information which has already been obtained, the updater adjusts version values of both of the configuration information and the composition information to be identical; and
the player plays back a component which is obtained on the basis of the configuration information of the latest version, on the basis of the composition information of a version identical to the latest version of the configuration information.

14. The playback apparatus according to claim 12, wherein the updater updates a version value of the other one of the configuration information and the composition information to a value identical to a version value of the obtained one of the configuration information and the composition information.

15. A distribution method for distributing one or more components forming content, the distribution method comprising:
a first distributing step of distributing configuration information and composition information, wherein the configuration information indicates a location from which the one or more components is obtained and the composition information indicates a playback mode of the one or more components; and
a second distributing step of distributing one of the configuration information and the composition information, and also distributing information indicating that the one or more components will continue to be obtained or played back on the basis of the other one of the configuration information and the composition information which has already been obtained.

16. A playback method for playing one or more components forming content, comprising:
an obtaining step of obtaining configuration information and composition information, wherein the configuration information indicates a location from which the one or more components is obtained and the composition information indicates a playback mode of the one or more components;
a playing step of performing a playback operation on the basis of the configuration information and the composition information; and
an updating step of updating, upon obtaining one of the configuration information and the composition information and information indicating that the one or more components will continue to be obtained or played back on the basis of the other one of the configuration information and the composition information which has already been obtained, the obtained one of the configuration information and the composition information by using the obtained information and updating both of the configuration information and the composition information to a latest version,
wherein the playing step plays back a component which is obtained on the basis of the configuration information of the latest version, on the basis of the composition information of the latest version.

17. A non-transitory computer-readable medium including a program for causing a computer to serve as the distribution apparatus according to claim 10 and for causing the computer to serve as the distributor.

18. A non-transitory computer-readable medium including a program for causing a computer to serve as the playback apparatus according to claim 11 and for causing the computer to serve as the obtainer, the player, and the updater.
